(19) United States
(12) Patent Application Publication
(10) Pub. No.: US 2017/0339704 A1
(43) Pub. Date: Nov. 23, 2017

(54) BASE STATION AND USER TERMINAL

(71) Applicant: KYOCERA CORPORATION, Kyoto (JP)

(72) Inventors: Naohisa MATSUMOTO, Higashiomi-shi (JP); Chiharu YAMAZAKI, Tokyo (JP); Hiroyuki URABAYASHI, Yokohama-shi (JP); Kugo MORITA, Higashiomi-shi (JP); Hiroyuki ADACHI, Kawasaki-shi (JP)

(73) Assignee: KYOCERA CORPORATION, Kyoto (JP)

(21) Appl. No.: 15/660,742

(22) Filed: Jul. 26, 2017

Related U.S. Application Data
(63) Continuation of application No. PCT/JP2016/052107, filed on Jan. 26, 2016.
(60) Provisional application No. 62/110,139, filed on Jan. 30, 2015.
(60) Provisional application No. 62/145,863, filed on Apr. 10, 2015.
(60) Provisional application No. 62/203,592, filed on Aug. 11, 2015.

(30) Foreign Application Priority Data
Aug. 11, 2015 (JP) 2015-159049

(51) Int. Cl. H04W 72/08; H04W 72/04; H04W 88/08; H04W 56/00; H04W 16/14

(52) U.S. Cl. CPC H04W 72/082; H04W 72/042; H04W 72/0446; H04W 16/14; H04W 56/001; H04W 88/08

(57) ABSTRACT

A base station according to a first aspect is used in a mobile communication system. The base station comprises: a transmitter configured to transmit, in an unlicensed band, a control signal and data by using a downlink subframe; and a controller configured to control transmission by the transmitter. The downlink subframe includes a PDCCH interval in which the control signal is arranged and a PDSCH interval in which the data is arranged. In the PDCCH interval, if there is an available region where the control signal is not arranged, the controller arranges a dummy signal in the available region.

### CROSS-REFERENCE TO RELATED APPLICATION

The present application is a continuation application based on PCT Application No. PCT/JP2016/052107 filed on Jan. 26, 2016, which claims the benefit of U.S. Provisional Application No. 62/110,139, (filed on Jan. 30, 2015), U.S. Provisional Application No. 62/145,863 (filed on Apr. 10, 2015), U.S. Provisional Application No. 62/203,592 (filed on Aug. 11, 2015) and Japan Patent Application No. 2015-159049 (filed on Aug. 11, 2015). The content of which is incorporated by reference herein in their entirety.

### FIELD

The present invention relates to a base station and a user terminal used in a mobile communication system.

### BACKGROUND

In recent years, in order to respond to rapidly increasing traffic demands in a mobile communication system, use of a specific frequency band shared by a plurality of operators and/or a plurality of communication systems for radio communication has been discussed. The specific frequency band is, for example, a frequency band in which a license is not required (unlicensed band).

In order to avoid interference with another operator and/or another communication system, a base station and a radio terminal configured to perform radio communication by using such a specific frequency band are requested to perform a clear channel determination process referred to as listen-before-talk (LBT).

The LBT is a procedure in which it is determined, based on received signal strength (interference power), whether or not a target channel in a specific frequency band is available, and only if the target channel is determined to be a clear channel, the target channel is used.

### SUMMARY OF THE INVENTION

A base station according to a first aspect is used in a mobile communication system. The base station comprises: a transmitter configured to transmit, in an unlicensed band, a control signal and data by using a downlink subframe; and a controller configured to control transmission by the transmitter. The downlink subframe includes a PDCCH interval in which the control signal is arranged and a PDSCH interval in which the data is arranged. In the PDCCH interval, if there is an available region where the control signal is not arranged, the controller arranges a dummy signal in the available region.

A base station according to a second aspect is used in a mobile communication system in which a downlink subframe including a PDCCH interval in which a control signal is arranged and a PDSCH interval in which data is arranged is defined. The base station comprises: a first transmitter configured to transmit the control signal, in a licensed band; and a second transmitter configured to transmit, in an unlicensed band, at least the data by using a special downlink subframe. The special downlink subframe includes a specific interval corresponding to the PDCCH interval. The specific interval is an interval where neither the control signal nor the data is arranged.

A base station according to a third aspect is used in a mobile communication system in which a downlink subframe including a PDCCH interval in which a control signal is arranged and a PDSCH interval in which data is arranged is defined. The base station comprises a transmitter configured to transmit, in an unlicensed band, at least the control signal and the data by using a special downlink subframe. The special downlink subframe is a subframe where the control signal and a specific downlink radio signal coexist in the PDCCH interval. The specific downlink radio signal is at least one of: a downlink synchronization signal, a downlink broadcast signal; and a header signal.

A base station according to a fifth aspect comprises a controller configured to perform a process of transmitting a downlink synchronization signal including operator information.

A base station according to a sixth aspect comprises a controller configured to perform a process of transmitting a discovery reference signal (DRS) a plurality of number of times, in one subframe of downlink.

A base station according to a sixth aspect comprises a controller configured to perform self-scheduling in an unlicensed band, wherein the controller performs a process of transmitting scheduling information to a user terminal by using an enhanced physical downlink control channel (ePDCCH).

A base station according to a seventh aspect performs radio communication with a user terminal in a specific frequency band shared by a plurality of operators and/or a plurality of communication systems. The base station comprises a controller configured to perform a process of transmitting a first synchronization signal at a start timing of downlink transmission to the user terminal, and transmitting a second synchronization signal at a timing different from the start timing. The controller differentiates a signal configuration related to the first synchronization signal from a signal configuration related to the second synchronization signal.

A user terminal according to an eighth aspect performs radio communication with a base station in a specific frequency band shared by a plurality of operators and/or a plurality of communication systems. The user terminal comprises a controller configured to perform a process of receiving, from the base station, a first synchronization signal at a start timing of downlink transmission to the user terminal and receiving, from the base station, a second synchronization signal at a timing different from the start timing. A signal configuration related to the first synchronization signal is different from a signal configuration related to the second synchronization signal. The controller distinguishes, based on a difference of the signal configuration, between the first synchronization signal and the second synchronization signal.

A radio communication apparatus according to a ninth aspect performs radio communication in a specific frequency band shared by a plurality of operators and/or a plurality of communication systems. The radio communication apparatus comprises a controller configured to perform, if the radio communication is performed over a plurality of subframes, a process of transmitting number-of-subframes information in a target subframe out of the plurality of subframes. The number-of-subframes information is information related to the number of subframes subsequent to the target subframe, out of the plurality of subframes.

A radio communication apparatus according to a tenth aspect performs radio communication in a specific frequency band shared by a plurality of operators and/or a plurality of communication systems. The communication apparatus comprises a controller configured to perform, if another radio communication apparatus performs radio communication in the specific frequency band over a plurality of subframes, a process of receiving number-of-subframes information from the other radio communication apparatus in a target subframe out of the plurality of subframes. The number-of-subframes information is information related to the number of subframes subsequent to the target subframe, of the plurality of subframes. The controller stops an operation of monitoring the specific frequency band, based on the number-of-subframes information.

A radio communication apparatus according to an eleventh aspect performs radio communication in a specific frequency band shared by a plurality of operators and/or a plurality of communication systems. The communication apparatus comprises a controller configured to perform, if starting transmission from a target symbol interval of a subframe including a plurality of symbol intervals, a process of transmitting number-of-symbols information in the target symbol interval. The number-of-symbols information is information related to the number of symbol intervals subsequent to the target symbol interval out of the plurality of symbol intervals.

A base station according to a twelfth aspect comprises a controller configured to transmit downlink data in an unlicensed band. The controller determines a start timing to start transmitting the downlink data, out of candidate start timings that are timings previously defined in a subframe.

### BRIEF DESCRIPTION OF THE DRAWINGS

FIG. 1 is a configuration diagram of an LTE system according to a first embodiment to a ninth embodiment.

FIG. 2 is a protocol stack diagram of a radio interface according to the first embodiment to the ninth embodiment.

FIG. 3 is a configuration diagram of a radio frame according to the first embodiment to the ninth embodiment.

FIG. 4 is a block diagram of a UE according to the first embodiment to the ninth embodiment.

FIG. 5 is a block diagram of an eNB according to the first embodiment to the ninth embodiment.

FIG. 6 is a diagram for describing LAA according to the first embodiment to the ninth embodiment.

FIG. 7 is a diagram illustrating a downlink subframe according to the first embodiment.

FIG. 8 is a diagram for describing a cross carrier scheduling according to the second embodiment.

FIG. 9 is a diagram illustrating a configuration example 1 of a special downlink subframe according to the second embodiment.

FIG. 10 is a diagram illustrating a configuration example 2 of the special downlink subframe according to the second embodiment.

FIG. 11 is a diagram illustrating a configuration example 1 of a special downlink subframe according to the third embodiment.

FIG. 12 is a diagram illustrating a configuration example 2 of the special downlink subframe according to the third embodiment.

FIG. 13 is a diagram illustrating a configuration example 3 of the special downlink subframe according to the third embodiment.

FIG. 14 is a diagram illustrating a configuration example 4 of the special downlink subframe according to the third embodiment.

FIG. 15 is a diagram illustrating a configuration example of a special downlink subframe according to a modification of the third embodiment.

FIG. 16 is a diagram illustrating a DRS transmitted by an eNB 200 according to the fifth embodiment.

FIG. 17 is a diagram illustrating a transmission of an ePDCCH according to the sixth embodiment.

FIG. 18 is a flow chart illustrating an example of LBT of an LBE scheme.

FIG. 19 is a diagram for describing a downlink transmission operation according to the seventh embodiment.

FIG. 20 is a diagram for describing a second method according to the seventh embodiment.

FIG. 21 is a diagram illustrating an example of a second synchronization signal according to the seventh embodiment.

FIG. 22 is a diagram illustrating an example of a first synchronization signal according to the seventh embodiment.

FIG. 23 is a diagram illustrating a modification of the seventh embodiment.

FIGS. 24(a) and 24(b) are diagrams for describing an operation according to the eighth embodiment.

FIG. 25 is a sequence diagram illustrating an example of the operation according to the eighth embodiment.

FIG. 26 is a diagram for describing an operation according to a first modification of the eighth embodiment.

FIG. 27 is a diagram for describing an operation according to a second modification of the eighth embodiment.

FIG. 28 is a flow chart illustrating an example of LBT of the LBE scheme.

FIG. 29 is a diagram for describing a downlink transmission operation according to the ninth embodiment.

FIG. 30 is a diagram illustrating a Listen failure before a DRS transmission according to an appendix 1.

FIG. 31 is a diagram illustrating an LAA DRS RSRP measurement according to the appendix 1.

FIG. 32 is a diagram illustrating an example of an existing channel mapping and a proposed channel mapping according to the appendix 1.

FIG. 33 is a diagram illustrating an example of an LTE beacon transmission according to an appendix 2.

FIG. 34 is a diagram illustrating an example of an LAA header according to the appendix 2.

FIG. 35 is a diagram illustrating an example of an Initial Signal according to an appendix 3.

FIG. 36 is a diagram illustrating an example of the Initial Signal and a DRS collision according to the appendix 3.

FIG. 37 is a diagram illustrating an example of a DRS physical design according to an appendix 4.

FIG. 38 is a diagram illustrating an example of an EPDCCH for LAA according to an appendix 5.

FIG. 39 is a diagram illustrating an example of an LAA scheduling according to the appendix 5.

FIG. 40 is a diagram illustrating a start timing of a DL data transmission according to an appendix 6.

FIGS. 41(a) and 41(b) are diagrams illustrating a reservation signal in one OFDM symbol according to the appendix 6.

FIG. 42 is a diagram illustrating a case example of a partial overlap according to the appendix 6.

FIG. 43 is a diagram illustrating an Initial Signal having two OFDM symbols according to the appendix 6.

### DESCRIPTION OF THE EMBODIMENT

### First Embodiment

(Overview of First Embodiment)

In an LTE system, a base station transmits a control signal to a user terminal via a physical downlink control channel (PDCCH). The control signal is arranged in a dispersed radio resource, and thus, the control signals arranged in the PDCCH interval may be sparse. In this case, overall power of the PDCCH interval becomes low.

Thus, even if the base station is transmitting a control signal on a frequency channel in an unlicensed band, there is a concern that another base station or another system may decide, according to the LBT procedure described above, the frequency channel to be a clear channel. Therefore, it is difficult to suitably perform LTE communication in an unlicensed band.

Therefore, an object of the first embodiment is to provide a base station by which it is possible to appropriately perform LTE communication in an unlicensed band.

A base station according to a first embodiment is used in a mobile communication system. The base station comprises: a transmitter configured to transmit, in an unlicensed band, a control signal and data by using a downlink subframe; and a controller configured to control transmission by the transmitter. The downlink subframe includes a PDCCH interval in which the control signal is arranged and a PDSCH interval in which the data is arranged. In the PDCCH interval, if there is an available region where the control signal is not arranged, the controller arranges a dummy signal in the available region.

In the first embodiment, the dummy signal is a downlink synchronization signal.

Alternatively, in the first embodiment, the dummy signal is a control signal in which an RNTI is applied, the RNTI being unassigned to a user terminal subordinate to the base station.

Hereinafter, an embodiment in the case where the present application is applied to LTE system will be described.

(Overview of LTE System)

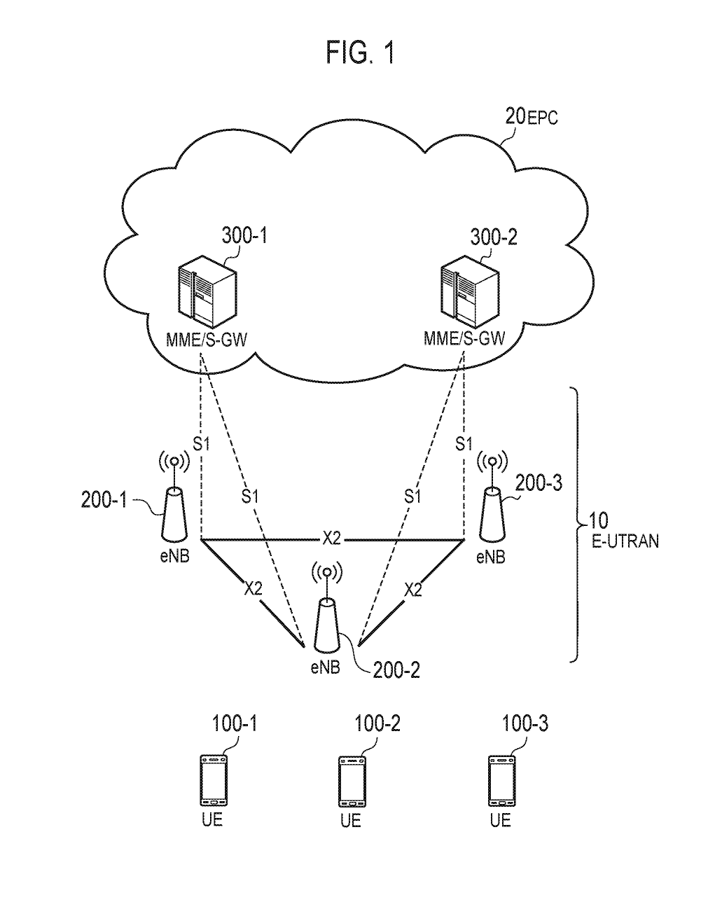

First, system configuration of the LTE system will be described. FIG. 1 is a configuration diagram of an LTE system.

As illustrated in FIG. 1, the LTE system includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell). Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data (hereinafter simply referred as “data”), and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer data. MME/S-GW 300 is connected to eNB 200 via an S1 interface. The E-UTRAN 10 and the EPC 20 constitute a network.

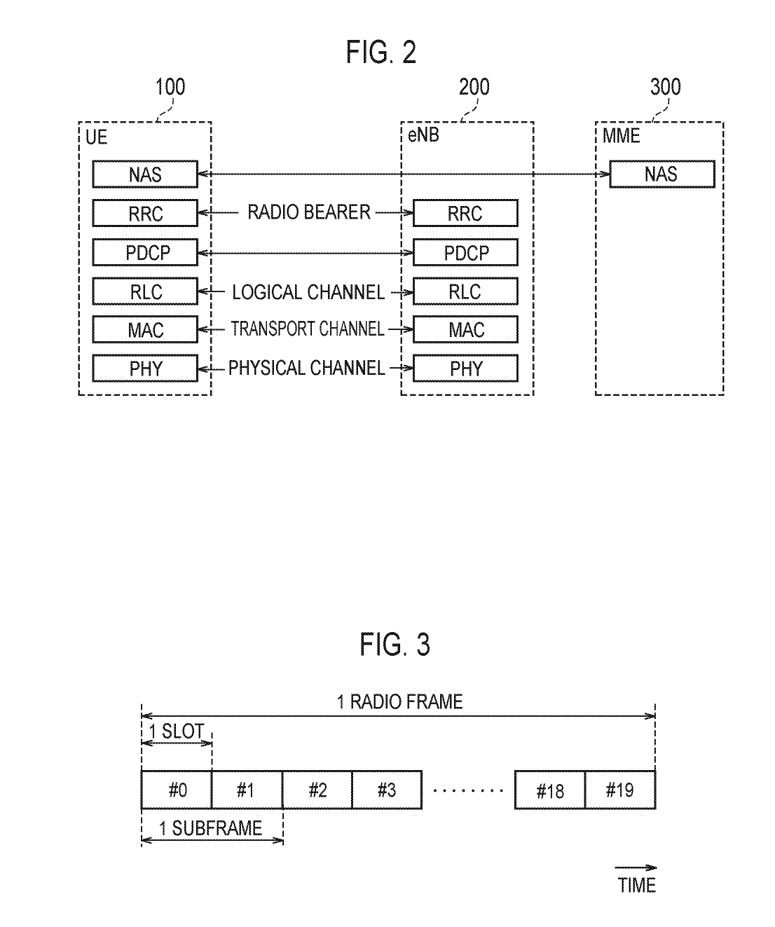

FIG. 2 is a protocol stack diagram of a radio interface in the LTE system. As illustrated in FIG. 2, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data and control signal are transmitted via the physical channel.

The MAC layer performs priority control of data, a retransmission process by hybrid ARQ (HARQ), and a random access procedure and the like. Between the MAC layer of the UE 100 and the MAC layer of the eNB 200, data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, message (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected state, otherwise the UE 100 is in an RRC idle state.

A NAS (Non-Access Stratum) layer positioned above the RRC layer performs a session management, a mobility management and the like.

FIG. 3 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 3, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction (not shown), and a plurality of symbols in the time direction. Each resource block includes a plurality of subcarriers in the frequency direction. One symbol and one subcarrier forms one resource element. Of the radio resources (time and frequency resources) assigned to the UE 100, a frequency resource can be identified by a resource block and a time resource can be identified by a subframe (or a slot).

In the downlink, an interval of several symbols at the head of each subframe is a control region used as a physical downlink control channel (PDCCH) for mainly transmitting a control signal. The details of the PDCCH will be described later. Furthermore, the other portion of each subframe is a region available as a physical downlink shared channel (PDSCH) for mainly transmitting downlink data. Furthermore, in each subframe, a downlink reference signal such as a cell specific reference signal (CRS) is arranged.

In the uplink, both ends in the frequency direction of each subframe are control regions used as a physical uplink control channel (PUCCH) for mainly transmitting an uplink control signal. Furthermore, the other portion of each subframe is a region available as a physical uplink shared channel (PUSCH) for mainly transmitting uplink data. Furthermore, in each subframe, an uplink reference signal such as a sounding reference signal (SRS) is arranged.

(Configuration of UE 100)

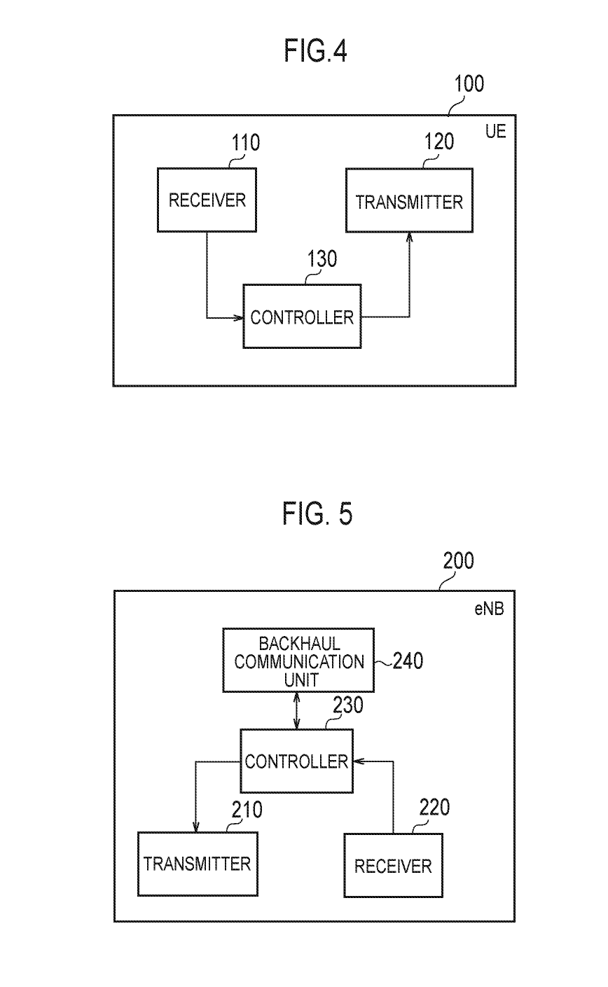

In the following, the configuration of the UE 100 (user terminal) will be described. FIG. 4 is a block diagram of a configuration of the UE 100. As illustrated in FIG. 4, the UE 100 includes a receiver 110, a transmitter 120, and a controller 130.

The receiver 110 performs various types of reception under the control of the controller 130. The receiver 110 includes an antenna and a receiving machine. The receiving machine converts a radio signal received by the antenna into a baseband signal (reception signal) and outputs it to the controller 130. The receiver 110 may include a first receiving machine for receiving a radio signal in a licensed band and a second receiving machine for receiving a radio signal in unlicensed bands.

The transmitter 120 performs various types of transmission under the control of the controller 130. The transmitter 120 includes an antenna and a transmitting machine. The transmitting machine converts a baseband signal (transmission signal) output from the controller 130 into a radio signal and transmits it from the antenna. The transmitter 120 may include a first transmitting machine for transmitting a radio signal in a licensed band and a second transmitting machine for transmitting a radio signal in an unlicensed band.

The controller 130 performs various controls in the UE 100. The controller 130 includes a processor and a memory. The memory stores programs executed by the processor and information used for processing by the processor. The processor includes a baseband processor that performs modulation and demodulation of the baseband signal, performs encoding and decoding, and the like, and a CPU (Central Processing Unit) that executes various programs by executing a program stored in the memory. The processor may include a codec for encoding/decoding audio/video signals. The processor executes various processes described later and various communication protocols described above.

The UE 100 may comprise a user interface and a battery. The user interface is an interface with a user possessing the UE 100, and includes, for example, a display, a microphone, a speaker, various buttons, and the like. The user interface receives an operation from the user and outputs a signal indicating the content of the operation to the controller 130. The battery stores electric power to be supplied to each block of the UE 100.

(Configuration of eNB 200)

In the following, the configuration of the eNB 100 (base station) will be described. FIG. 5 is a block diagram of the eNB 200. As illustrated in FIG. 5, the eNB 200 includes a transmitter 210, a receiver 220, a controller 230, and a backhaul communication unit 240.

The transmitter 210 performs various transmissions under the control of the controller 230. The transmitter 210 includes an antenna and a transmitting machine. The transmitting machine converts a baseband signal (transmission signal) output from the controller 130 into a radio signal and transmits it from the antenna. The transmitter 210 may include a first transmitting machine for transmitting a radio signal in a licensed band and a second transmitting machine for transmitting a radio signal in an unlicensed band.

The receiver 220 performs various types of reception under the control of the controller 230. The receiver 220 includes an antenna and a receiving machine. The receiving machine converts a radio signal received by the antenna into a baseband signal (reception signal) and outputs it to the controller 230. The receiver 220 may include a first receiving machine for receiving a radio signal in a licensed band and a second receiving machine for receiving a radio signal in unlicensed bands.

The controller 230 performs various controls in the eNB 200. The controller 230 includes a processor and a memory. The memory stores programs executed by the processor and information used for processing by the processor. The processor includes a baseband processor that performs modulation and demodulation of the baseband signal, performs encoding and decoding, and the like, and a CPU (Central Processing Unit) that executes various programs by executing a program stored in the memory. The processor executes various processes described later and various communication protocols described above.

The backhaul communication unit 240 is connected to a neighbor eNB 200 via the X2 interface, and is connected to the MME/S-GW 300 via the S1 interface. The backhaul communication unit 240 is used for communication performed on the X2 interface, communication performed on the S1 interface, and the like.

(LAA)

The LTE system according to the first embodiment uses, for LTE communication, not only a licensed band for which the license is granted to operators, but also an unlicensed band for which the license is not required. Specifically, with an assistance of the licensed band, it is possible to access the unlicensed band. Such a structure is referred to as licensed-assisted access (LAA).

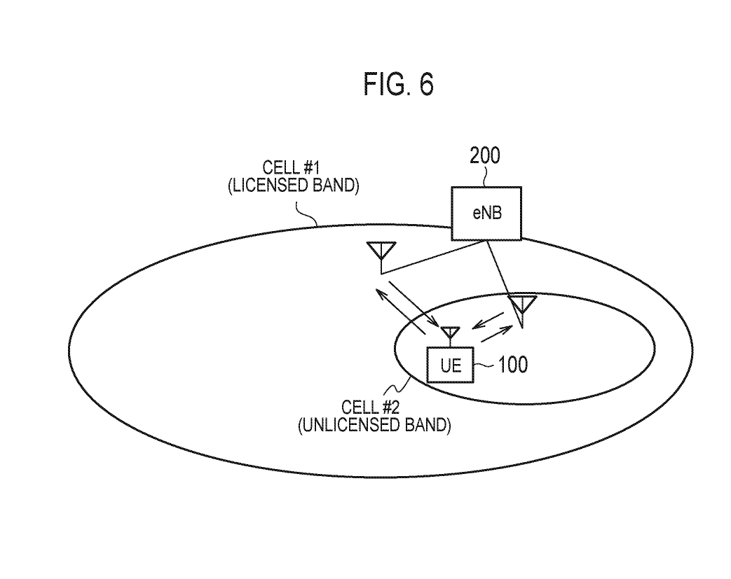

FIG. 6 is a diagram for describing LAA. As illustrated in FIG. 6, the eNB 200 manages a cell #1 operated in a licensed band and a cell #2 operated in an unlicensed band. In FIG. 6, an example is illustrated where the cell #1 is a macro cell and the cell #2 is a small cell, but a cell size is not limited to this.

The UE 100 is located in an overlapping area of the cell #1 and the cell #2. The UE 100 sets the cell #1 as a primary cell (PCell) while setting the cell #2 as a secondary cell (SCell), and performs communication by carrier aggregation (CA).

In an example of FIG. 6, the UE 100 performs uplink communication and downlink communication with the cell #1 and downlink communication with the cell #2. By such carrier aggregation, the UE 100 is provided, in addition to with a radio resource of the licensed band, with a radio resource of the unlicensed band, and thus, the UE 100 can improve downlink throughput.

In the unlicensed band, in order to avoid interference with a system (such as wireless LAN) different from an LTE system or an LTE system of another operator, a listen-before-talk (LBT) procedure is requested. The LBT procedure is a procedure in which it is confirmed, based on received power, whether or not a frequency channel is available, and only if it is confirmed that the frequency channel is a clear channel, the frequency channel is used.

Thus, the eNB 200 searches for a clear channel in the cell #2 (unlicensed band), and allocates a radio resource included in the clear channel to the UE 100 by the LBT procedure (scheduling).

In the first embodiment, the eNB 200 performs scheduling in the cell #2 via a PDCCH of the cell #2. It is noted that a case of performing scheduling in the cell #2 via a PDCCH of the cell #1 (that is, cross carrier scheduling) will be described in a third embodiment.

(Downlink Subframe, PDCCH)

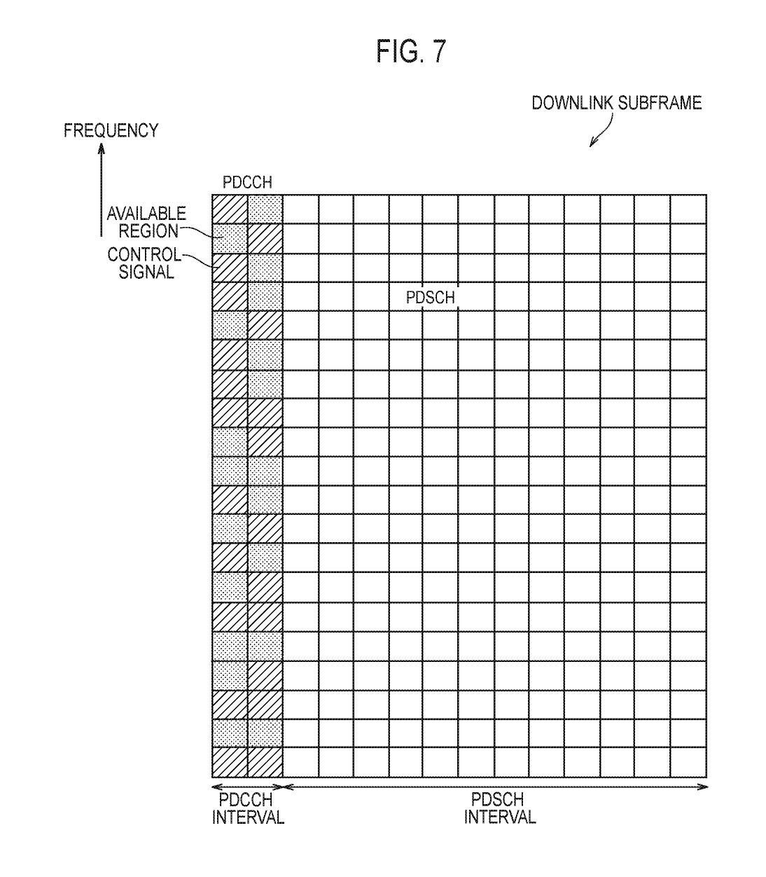

FIG. 7 is a diagram illustrating a downlink subframe. As illustrated in FIG. 7, the downlink subframe includes a PDCCH interval in which a control signal (downlink control signal) is arranged and a PDSCH interval in which data (downlink data) is arranged. In FIG. 7, an example is illustrated in which the PDCCH interval has a symbol length of two symbols, but the PDCCH interval can be modified in the range of one to three symbols long.

The control signal includes scheduling information (L1/L2 control information) for notifying a resource allocation result for the downlink and the uplink. In order to identify a UE 100 to which the control signal is transmitted, the eNB 200 includes a CRC bit scrambled by an identifier (Radio Network Temporary ID: RNTI) of the UE 100 to which the control signal is transmitted, into the control signal. In the control signal possibly addressed to the UE 100, the UE 100 descrambles the CRC bit by the RNTI of the UE to thereby blind-decode the PDCCH to detect the control signal addressed to the UE 100.

The control signal is arranged in the dispersed radio resource (resource element). In the example of FIG. 7, the control signal is arranged in substantially about a half of the resource elements, among all resource elements of the PDCCH interval, and a control signals is not arranged in the remaining resource elements. A region formed of the resource elements where a control signal is not arranged is referred to as an “available region”. In this manner, as a result of the control signals arranged in the PDCCH interval becoming sparse, the overall power of the PDCCH interval can become low.

In an operation environment illustrated in FIG. 6, a case is assumed where the eNB 200 uses the downlink subframe illustrated in FIG. 7 to transmit a control signal and data on the frequency channel of the cell #2 (unlicensed band).

In this case, the power in the PDCCH interval is low, and thus, there is a concern that another eNB or another system may decide, according to the LBT procedure, that the frequency channel used by the eNB 200 is a clear channel. As a result, an interference occurs on the frequency channel, and thus, the eNB 200 cannot suitably perform LTE communication.

Here, in order to solve such a problem, the following operations may be considered.

In the unlicensed band, the transmitter 210 uses the downlink subframe to transmit a control signal and data. In the example in FIG. 6, the eNB 200 transmits to the UE 100 a control signal and data on the frequency channel of the cell #2 (unlicensed band). As described above, the downlink subframe includes the PDCCH interval in which a control signal is arranged, and the PDSCH interval in which data is arranged.

In the PDCCH interval, the controller 230 of the eNB 200 raises transmission power of a control signal if there is an available region (see FIG. 7) where a control signal is not arranged. In the example of FIG. 7, the transmission power of each resource element where a control signal is arranged in the PDCCH interval is raised. Here, “the transmission power of a control signal is raised” means that a control signal is transmitted at least with a power higher than a normal transmission power of a control signal. If there is an available region in the PDCCH interval, the controller 230 of the eNB 200 raises the transmission power of a control signal to come close to the transmission power of all PDCCH intervals when there is no available region.

However, in some countries, laws and regulations prohibit a method of raising (boosting) the transmission power of a control signal.

Therefore, in the first embodiment, the eNB 200 arranges a dummy signal in the available region (see FIG. 7) to increase the power in the PDCCH interval, without raising the transmission power of a control signal.

(Operation According to First Embodiment)

An operation of the eNB 200 to suitably perform LTE communication in an unlicensed band will be described, below.

In an unlicensed band, the transmitter 210 of the eNB 200 according to the first embodiment transmits a control signal and data by using a downlink subframe. As described above, the downlink subframe includes the PDCCH interval in which a control signal is arranged, and the PDSCH interval in which data is arranged.

In the PDCCH interval, if there is an available region (see FIG. 7) where a control signals is not arranged, the controller 230 of the eNB 200 arranges a dummy signal in the available region. In an example of Fig. 7, a dummy signal is arranged in all resource elements where a control signals is not arranged in the PDCCH interval. However, this is not limited to a case where a dummy signal is arranged in all resource elements where a control signals is not arranged. A dummy signal may be arranged only in some of the resource elements where a control signal is not arranged.

In this manner, it is possible to raise the power in the PDCCH interval, by arranging a dummy signal in an available region in the PDCCH interval.

Here, the dummy signal may be a downlink synchronization signal. The downlink synchronization signal is, for example, a primary synchronization signal (PSS) and a secondary synchronization signal (SSS). A case is assumed where a new carrier structure different from the carrier structure used in the licensed band is applied in the unlicensed band. The new carrier structure is, for example, a carrier structure having a low downlink synchronization signal density. When using such a new carrier structure, it becomes difficult to establish the downlink synchronization compared to the licensed band. Therefore, when a downlink synchronization signal is arranged in an available region in the PDCCH interval, it is possible to facilitate the establishment of downlink synchronization. Specifically, the receiver 110 of the UE 100 synchronizes based on a synchronization signal in the PDCCH interval while decoding a control signal in the PDCCH interval.

Alternatively, the dummy signal may be a specific downlink radio signal where an RNTI is not applied. Generally, an RNTI (C-RNTI) is applied to a control signal transmitted on the PDCCH, and thus, even if a signal to which an RNTI is not applied (specific downlink radio signal) is transmitted on the PDCCH, the signal is not decoded in the UE 100. So the UE 100 is not adversely affected. The specific downlink radio signal may be a header signal or a downlink broadcast signal, described below.

Alternatively, the dummy signal may be a control signal in which an RNTI unassigned to the UE 100 is applied. The unassigned RNTI is an RNTI not assigned to each UE 100 in the cell #2 in the unlicensed band (see FIG. 6). Even if a control signal to which such a RNTI is applied is transmitted on the PDCCH, the control signal is not decoded in the UE 100, and thus, the UE 100 is not adversely affected.

(Summary of First Embodiment)

In the first embodiment, if there is an available region in the PDCCH interval of a downlink subframe used in a frequency channel in an unlicensed band, the eNB 200 arranges a dummy signal in the available region. Thereby, it is possible to raise the power in the PDCCH interval without boosting a control signal, and thus, another eNB or another system does not decide, according to the LBT procedure, that the frequency channel used by the eNB 200 is a clear channel. As a result, the eNB 200 can continue the use of the frequency channel and LTE communication may suitably be performed.

### Second Embodiment

(Overview of Second Embodiment)

A base station according to a second embodiment is used in a mobile communication system in which a downlink subframe including the PDCCH interval in which a control signal is arranged and the PDSCH interval in which data is arranged is defined. The base station includes: a first transmitter configured to transmit the control signal, in a licensed band; and a second transmitter configured to transmit, in an unlicensed band, at least the data by using a special downlink subframe. The special downlink subframe includes a specific interval corresponding to the PDCCH interval. The specific interval is an interval where neither the control signal nor the data is arranged.

In the second embodiment, a specific downlink radio signal different from the control signal is arranged in the specific interval.

In the second embodiment, the specific downlink radio signal is at least one of: a downlink synchronization signal, a downlink broadcast signal, and a header signal. The header signal is a signal including scheduling information corresponding to the control signal.

The second embodiment will be described while focusing on differences from the first embodiment, below. In the second embodiment, scheduling in an unlicensed band is performed by cross carrier scheduling.

(Cross Carrier Scheduling)

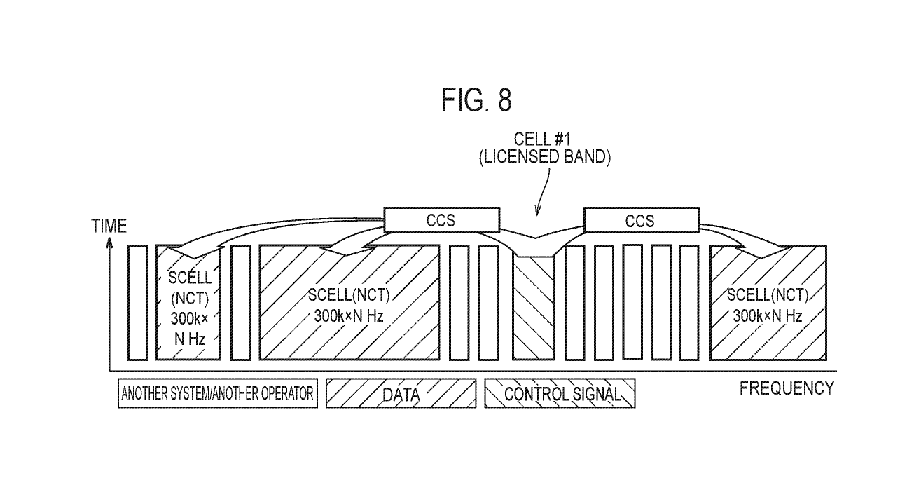

The cross carrier scheduling will be described, below. FIG. 8 is a diagram for describing the cross carrier scheduling.

As illustrated in FIG. 8, the cross carrier scheduling is a scheduling technique of transmitting scheduling information of another carrier (another frequency) in one carrier (one frequency).

In the example of FIG. 6, the eNB 200 transmits the control signal in the cell #2 (unlicensed band) to the UE 100 via the cell #1 (licensed band). The control signal includes scheduling information in the cell #2 (unlicensed band). The UE 100 receives data from the cell #2 in accordance with the control signal received via the cell #1.

If such cross carrier scheduling is used, the transmission of the control signal in the cell #2 (unlicensed band) may become unnecessary.

(Operation According to Second Embodiment)

An operation of the eNB 200 to suitably perform LTE communication in an unlicensed band will be described, below.

The eNB 200 according to the second embodiment is used in an LTE system in which a downlink subframe including the PDCCH interval in which a control signal is arranged and the PDSCH interval in which data is arranged is defined.

The eNB 200 includes: the first transmitter configured to transmit the control signal, in the licensed band (a transmitter unit #1 of the transmitter 210); and the second transmitter (a transmitter unit #2 of the transmitter 210) configured to transmit, in the unlicensed band, at least the data by using the special downlink subframe. The special downlink subframe includes a specific interval corresponding to the PDCCH interval. The specific interval is an interval where neither a control signal nor data is arranged. In this manner, even if the cross carrier scheduling is used, an interval corresponding to the PDCCH interval (specific interval) is purposefully set. Thereby, a format of the PDCCH interval is maintained, and thus it is possible to minimize the impact of changing the PDSCH reception operation of the UE 100.

Further, in the specific interval, a specific downlink radio signal different from the control signal is arranged in the PDCCH interval. Thereby, it is possible to effectively use the specific interval.

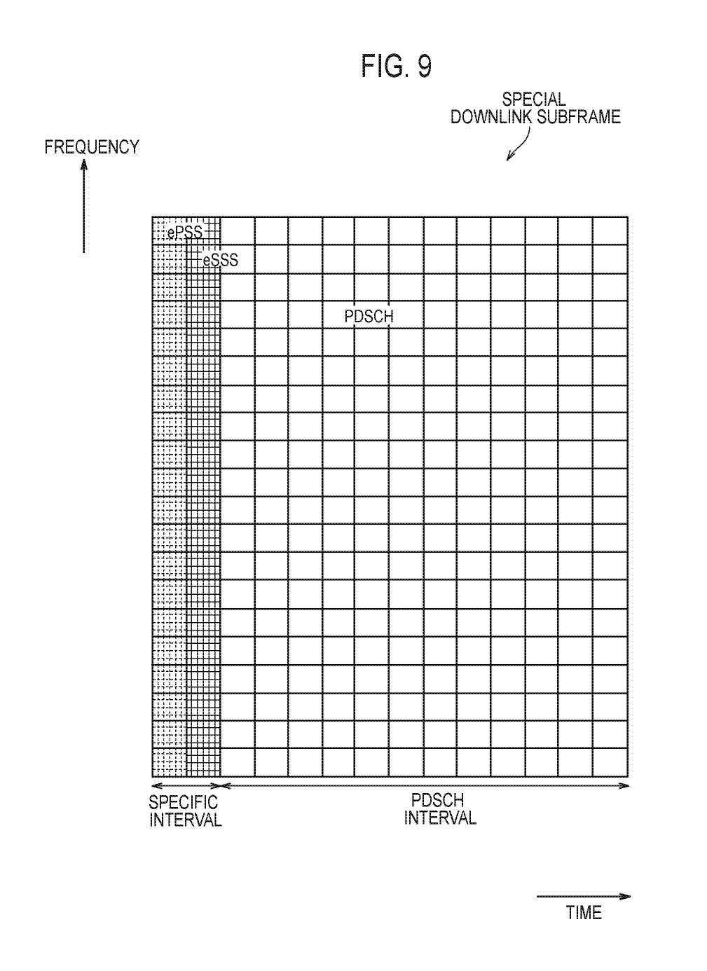

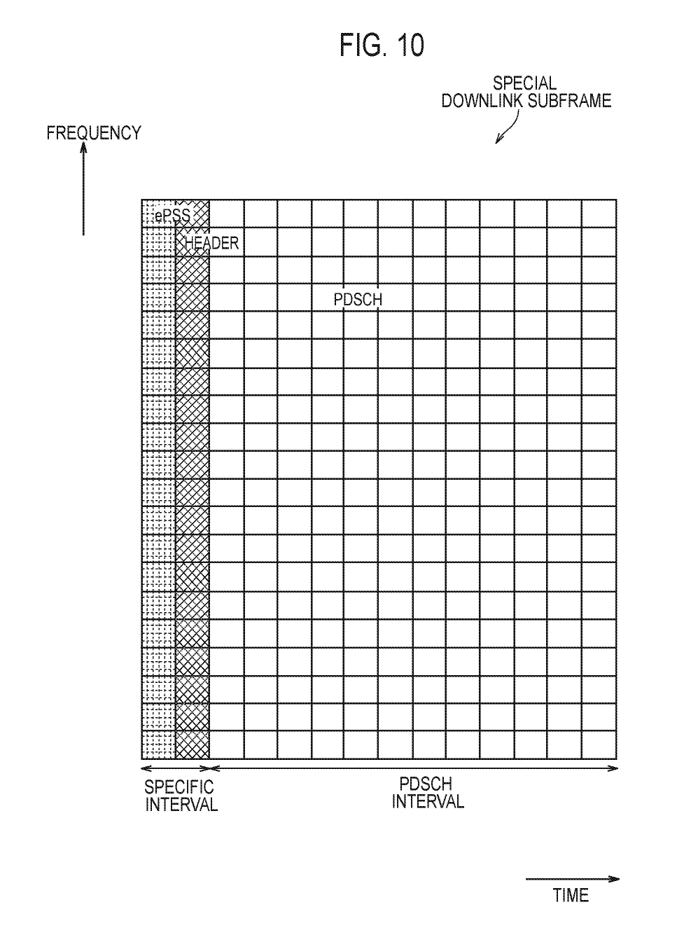

FIG. 9 is a diagram illustrating a configuration example 1 of the special downlink subframe used in the unlicensed band. FIG. 10 is a diagram illustrating a configuration example 2 of the special downlink subframe used in the unlicensed band. Although an example of a specific interval having a symbol length of two symbols is illustrated, the specific interval can be modified in the range of one to three symbols long similarly to the PDCCH interval.

As illustrated in FIG. 9, in the configuration example 1, in the special downlink subframe, a downlink synchronization signal different from the control signal (specific downlink radio signal) is arranged in the specific interval. The downlink synchronization signal is, for example, a primary synchronization signal (PSS) and a secondary synchronization signal (SSS). A general downlink synchronization signal is arranged only at a central portion of the downlink bandwidth, but the downlink synchronization signal illustrated in FIG. 9 is arranged across the entire downlink bandwidth. Therefore, such a primary synchronization signal (PSS) and a secondary synchronization signal (SSS) may be referred to as an enhanced primary synchronization signal (ePSS) and an enhanced secondary synchronization signal (eSSS). Specifically, the ePSS is arranged in a first symbol (header symbol) of the specific interval, and the eSSS is arranged in a second symbol therein.

According to such a configuration example 1 of the special downlink subframe, it is possible to facilitate the establishment of downlink synchronization.

As illustrated in FIG. 10, in the configuration example 2, in the special downlink subframe, a downlink synchronization signal and a header signal are arranged across the entire specific interval (all bands). Specifically, the enhanced primary synchronization signal (ePSS) is arranged in the first symbol (header symbol) of the specific interval and the header signal is arranged in the second symbol of the specific interval. The header signal includes scheduling information corresponding to the control signal. Further, the header signal may include information such as an allocation MCS, an allocated UE number, an allocation period, transmission power information, and the like.

According to such a configuration example 2 of the special downlink subframe, it is possible to facilitate the establishment of the downlink synchronization and facilitate downlink data transmission. Specifically, the receiver 110 of the UE 100 can take synchronization based on the ePSS in the specific interval and decode the header signal in the specific interval to the data assignment to know data allocation.

Alternatively, instead of the downlink synchronization signal and the header signal, a downlink broadcast signal may be arranged. The downlink broadcast signal is, for example, a system information block (SIB).

In both FIG. 9 and FIG. 10, it should be noted that the structure (format) of the PDSCH interval is the same as the structure of the PDSCH interval of a general subframe. Thereby, the specific interval is effectively used while maintaining the existing PDSCH structure.

(Summary of Second Embodiment)

In the second embodiment, the eNB 200 uses a special downlink subframe in an unlicensed band. The special downlink subframe is a subframe in which a specific downlink radio signal different from a control signal is arranged in a specific interval. Thereby, the power in the specific interval is increased, and thus, another eNB or another system does not decide, according to the LBT procedure, that the frequency channel used by the eNB 200 is a clear channel. As a result, the eNB 200 can continue the use of the frequency channel and LTE communication may suitably be performed. Further, it is possible to effectively use the specific interval while maintaining the existing PDSCH structure.

### Third Embodiment

(Overview of Third Embodiment)

A base station according to a third embodiment is used in a mobile communication system in which a downlink subframe including the PDCCH interval in which a control signal is arranged and the PDSCH interval in which data is arranged is defined. The base station includes a transmitter configured to transmit, in an unlicensed band, at least the control signal and the data by using a special downlink subframe. The special downlink subframe is a subframe where the control signal and a specific downlink radio signal coexist in the PDCCH interval. The specific downlink radio signal is at least one of: a downlink synchronization signal, a downlink broadcast signal, and a header signal.

In the third embodiment, the header signal is a signal including scheduling information corresponding to the control signal.

In the third embodiment, the specific downlink radio signal is arranged in part of the symbol intervals in the PDCCH interval of the special downlink subframe. The specific downlink radio signal is arranged across the entire frequency band of the part of the symbol intervals.

In the third embodiment, the specific downlink radio signal is arranged in at least part of the symbol intervals in the PDCCH interval of the special downlink subframe. In at least the part of the symbol intervals, the control signal and the specific downlink radio signal are arranged in a frequency division manner.

In the third embodiment, in at least the part of the symbol intervals, the specific downlink radio signal is arranged in an available region where the control signal is not arranged.

In the third embodiment, in at least the part of the symbol intervals, a frequency band where the specific downlink radio signal is arranged is defined, and the control signal is arranged in the available region where the specific downlink radio signal is not arranged.

In the third embodiment, in the PDCCH interval of the special downlink subframe, instead of the control signal, a header signal including scheduling information corresponding to the control signal is arranged.

The third embodiment will be described while focusing on the differences from the first and the second embodiments, below. The third embodiment is similar to the above-described embodiments in that a special downlink subframe is used in an unlicensed band. However, the third embodiment is different to the above-described embodiments in that cross carrier scheduling is not assumed.

(Operation According to Third Embodiment)

An operation of the eNB 200 to suitably perform LTE communication in an unlicensed band will be described, below.

The eNB 200 according to the third embodiment is used in an LTE system in which a downlink subframe including the PDCCH interval in which a control signal is arranged and the PDSCH interval in which data is arranged is defined.

In an unlicensed band, the transmitter 210 of the eNB 200 transmits at least a control signal and data by using a special downlink subframe. The special downlink subframe is a subframe where a control signal and a specific downlink radio signal coexist in the PDCCH interval. The specific downlink radio signal is a signal different from the control signal. The specific downlink radio signal is at least one of: a downlink synchronization signal, a downlink broadcast signal, and a header signal.

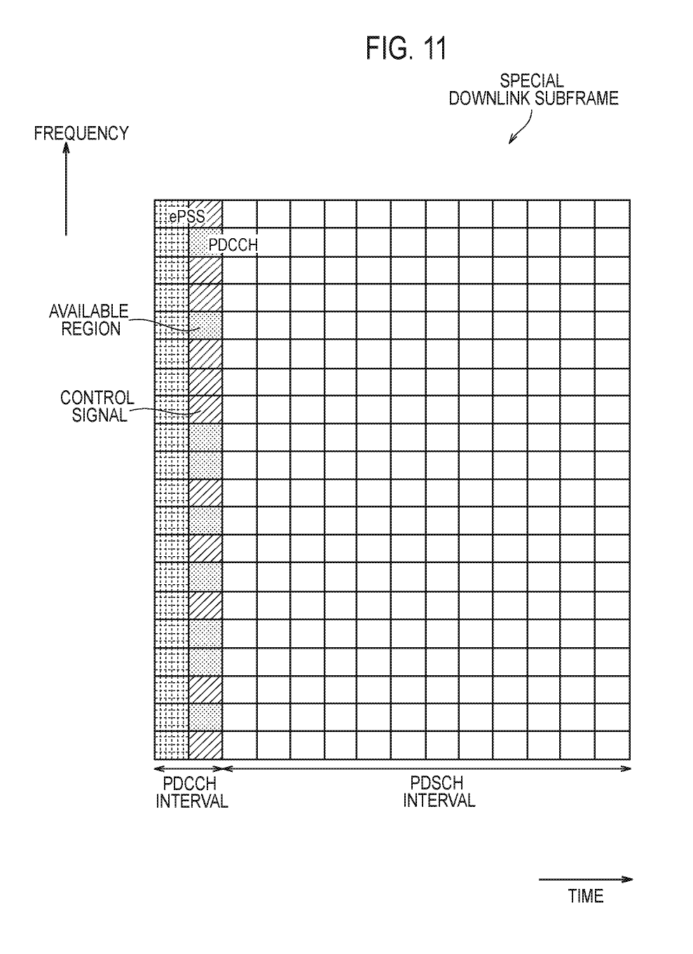

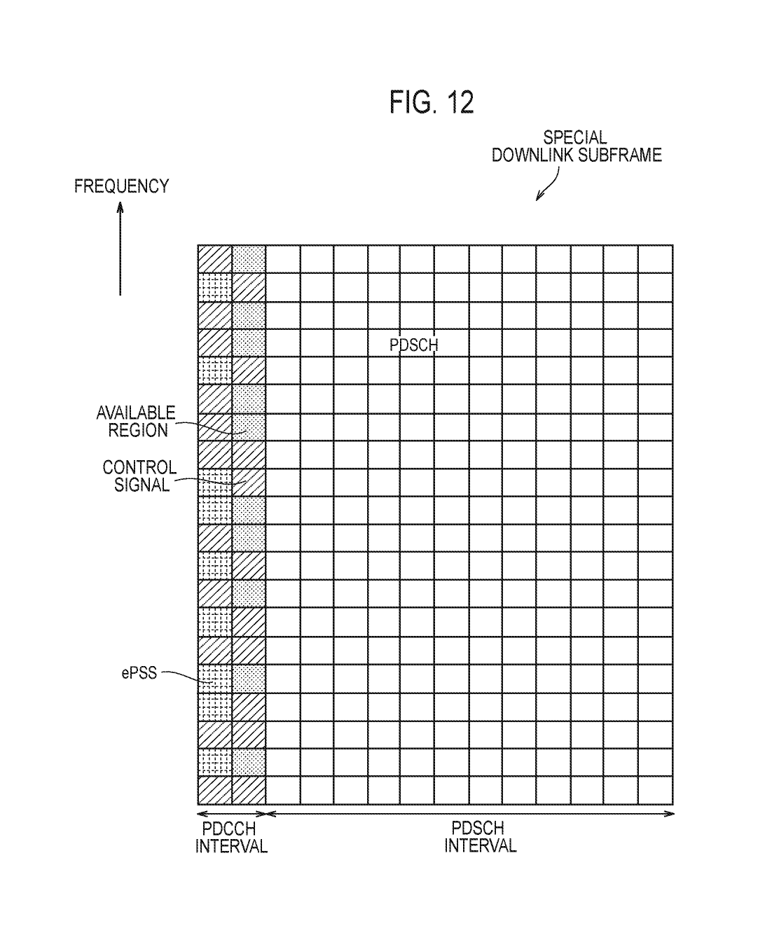

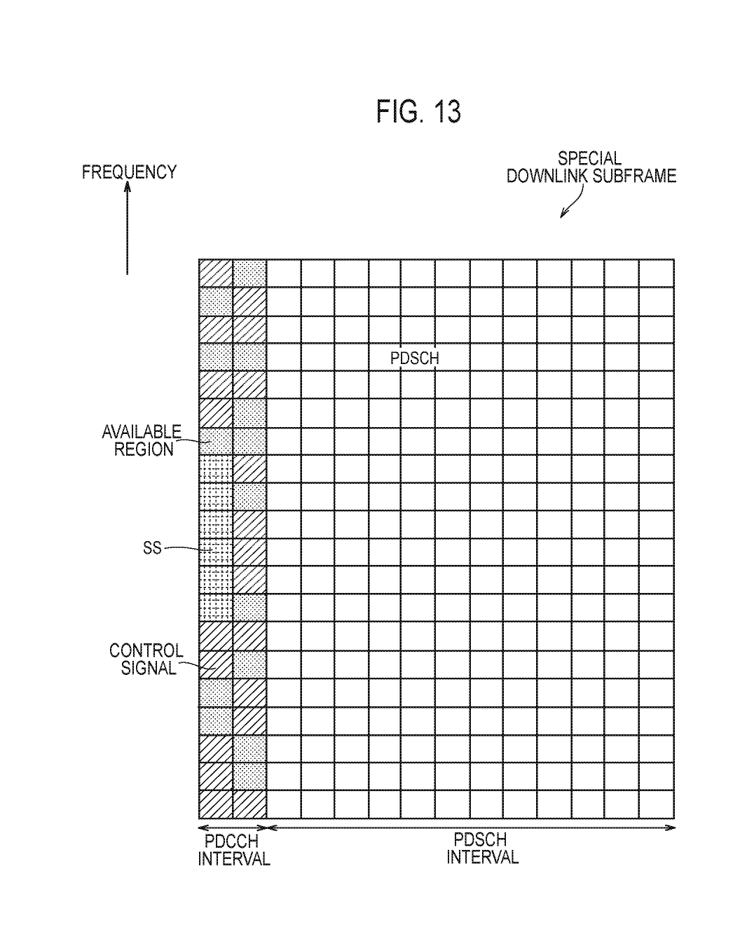

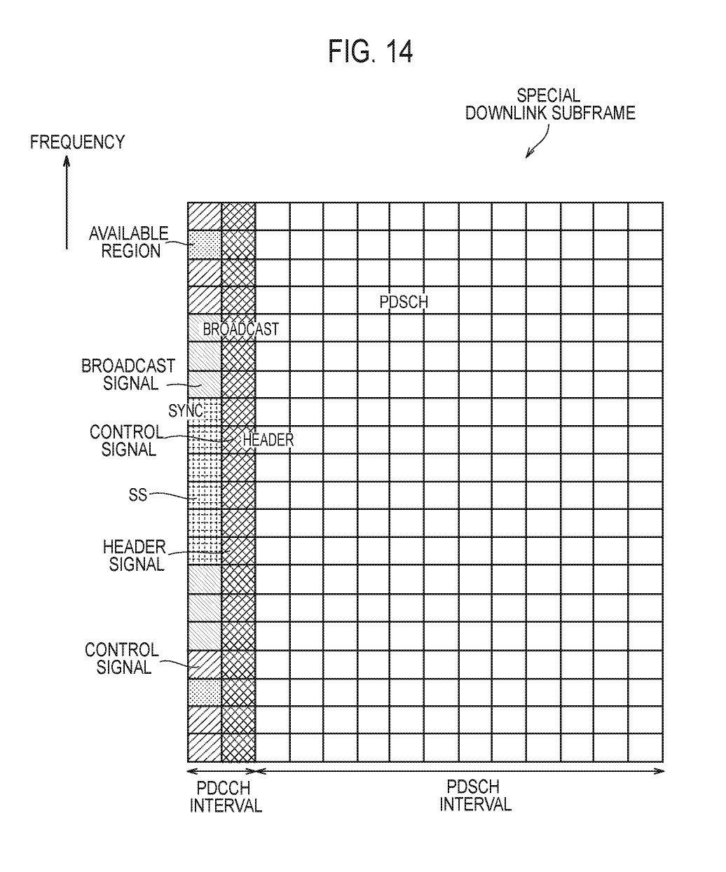

FIG. 11 is a diagram illustrating a configuration example 1 of a special downlink subframe according to the third embodiment. FIG. 12 is a diagram illustrating a configuration example 2 of the special downlink subframe according to the third embodiment. FIG. 13 is a diagram illustrating a configuration example 3 of the special downlink subframe according to the third embodiment. FIG. 14 is a diagram illustrating a configuration example 4 of the special downlink subframe according to the third embodiment. Although an example in which the PDCCH interval having a symbol length of two symbols is illustrated, the PDCCH interval can be modified in the range of one to three symbols long.

As illustrated in FIG. 11, in the configuration example 1, an ePSS (specific downlink radio signal) is arranged in part of the symbol intervals in the PDCCH interval of the special downlink subframe. The ePSS is arranged across the entire frequency band of the part of the symbol intervals. Specifically, the ePSS (downlink synchronization signal) is arranged in the first symbol (header symbol) of the PDCCH interval, and a control signal is arranged in the second symbol of the PDCCH interval. The control signal is arranged in a resource element dispersed in a frequency direction, and thus, an available region is generated in the second symbol interval. A dummy signal described in the second embodiment may be arranged in the available region.

As illustrated in FIG. 12, in the configuration example 2, the ePSS (specific downlink radio signal) is arranged in part of the symbol intervals in the PDCCH interval of the special downlink subframe. Specifically, in the first symbol (header symbol) of the PDCCH interval, the ePSS is arranged in an available region where the control signal is not arranged. In the second symbol of the PDCCH interval, only the control signal is arranged. The control signal is arranged in a resource element dispersed in a frequency direction, and thus, an available region is generated in the second symbol interval. A dummy signal described in the second embodiment may be arranged in the available region.

As illustrated in FIG. 13, in the configuration example 3, an SS (specific downlink radio signal) is arranged in part of the symbol intervals (first symbol interval) in the PDCCH interval of the special downlink subframe. The SS is, for example, a primary synchronization signal. In part of the symbol intervals (first symbol interval), the control signal and the SS are arranged in a frequency division manner. Further, in the part of the symbol intervals (first symbol interval), a frequency band in which the SS is arranged is defined. For example, the SS is arranged in the central portion in the frequency direction in the first symbol (header symbol) of the PDCCH interval. The control signal is arranged in an available region where the SS is not arranged. Only a portion to which the SS (SYNC) is not assigned may be set as a candidate PDCCH assignment location, and a PDCCH assignment location may be overwritten with the SYNC after PDCCH assignment without considering the SYNC. The control signal is arranged in a resource element dispersed in the frequency direction, and thus, the first and the second symbol intervals have an available region. A dummy signal described in the second embodiment may be arranged in the available region.

As illustrated in FIG. 14, in the configuration example 4, in part of the symbol intervals (first symbol interval) in the PDCCH interval of the special downlink subframe, the control signal and specific downlink radio signals (SS and broadcast signal) are arranged in a frequency division manner. Specifically, the SS is arranged in the central portion in the frequency direction in the first symbol (header symbol) of the PDCCH interval. The broadcast signal is arranged outside the SS in the frequency direction. The control signal is arranged outside the broadcast signal in the frequency direction. The header signal is arranged across the entire frequency band in the second symbol interval of the PDCCH interval.

According to the configuration examples 1 to 3 of the special downlink subframe, it is possible to facilitate establishment of downlink synchronization and to facilitate downlink data transmission. Specifically, the receiver 110 of the UE 100 can take synchronization based on the downlink synchronization signal in the PDCCH interval and decode the control signal (and header signal) in the PDCCH interval to know data assignment.

(Summary of Third Embodiment)

In the third embodiment, the eNB 200 uses a special downlink subframe in an unlicensed band. The special downlink subframe is a subframe where a control signal and a specific downlink radio signal coexist in the PDCCH interval. The specific downlink radio signal includes a downlink synchronization signal. When the specific downlink radio signal is arranged in the PDCCH interval, the power in the PDCCH interval is increased, and thus, another eNB or another system does not decide, according to the LBT procedure, that the frequency channel used by the eNB 200 is a clear channel. As a result, the eNB 200 can continue the use of the frequency channel and LTE communication may suitably be performed. Further, it is possible to facilitate establishment of downlink synchronization and to facilitate downlink data transmission.

(Modification of Third Embodiment)

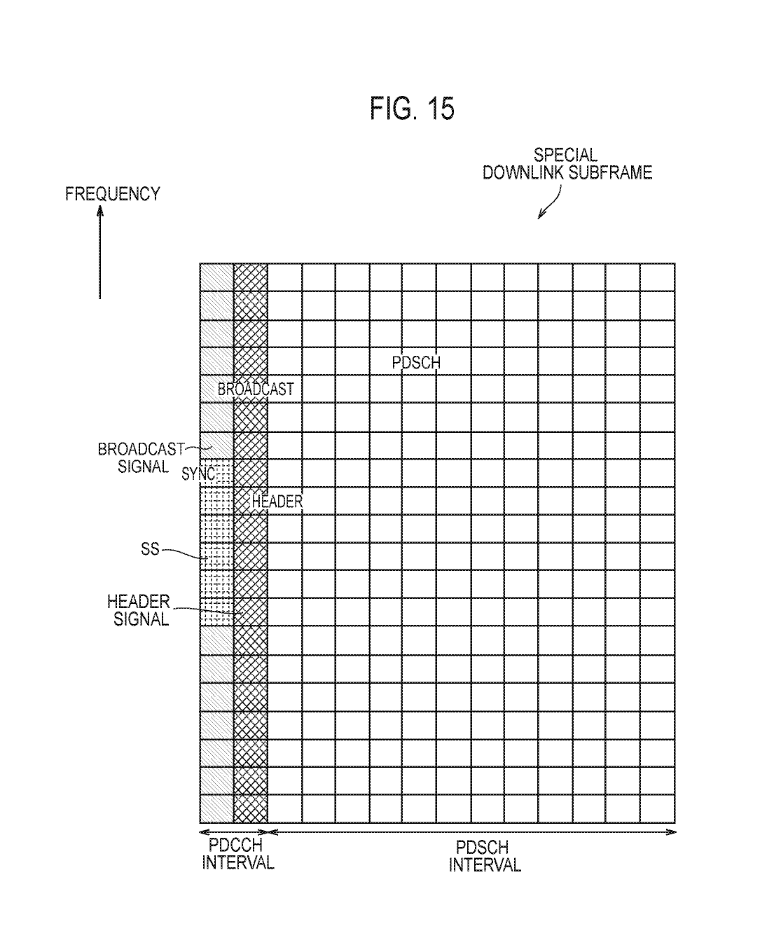

FIG. 15 is a diagram illustrating a configuration example of a special downlink subframe according to a modification of the third embodiment. As illustrated in FIG. 15, in the PDCCH interval of the special downlink subframe, instead of the control signal, a header signal including the scheduling information corresponding to the control signal may be arranged. In the present configuration example, in the first symbol interval of the PDCCH interval of the special downlink subframe, the SS is arranged in the central portion in the frequency direction. The broadcast signal is arranged outside the SS in the frequency direction. The header signal is arranged across the entire frequency band in the second symbol interval of the PDCCH interval.

### Fourth Embodiment

(Overview of Fourth Embodiment)

A base station according to a fourth embodiment includes a controller configured to perform a process of transmitting a downlink synchronization signal including operator information.

(Operation According to Fourth Embodiment)

The eNB 200 transmits a downlink synchronization signal (primary synchronization signal (PSS) or secondary synchronization signal (SSS)) including operator information (such as operator ID). It is noted that the operator information may be an operator configured to manage the eNB 200, as an example.

Specifically, while maintaining a number of patterns of an existing downlink synchronization signal, the eNB 200 may include operator information in an area of an available downlink synchronization signal by setting a number of patterns of cell identification information (a cell ID) smaller than the existing cell identification information. It is noted that the eNB 200 may transmit the information (such as a cell ID) according to a pattern of a sequence of the downlink synchronization signal. For example, the eNB 200 may be capable of multiplying three patterns of the PSS and 168 patterns of the SSS to transmit 504 patterns of cell IDs. Further, the eNB 200 may use the PSS as the operator information or a portion of the SSS as the operator information. Alternatively, the eNB 200 may include the operator information into the added area, by modifying the number of patterns of the downlink synchronization signal from the existing number of patterns (specifically, the number of the downlink synchronization signal patterns are increased only for the amount of operator information).

Further, one cell managed by the eNB 200 may multiplex and transmit, in bit units, data for a cell of the eNB 200, data for another cell, and/or data for which a target is not limited. Here, the data for a cell of the eNB 200 may be data that can be decoded by a cell of the eNB 200 (or a UE 100 located in a cell of the eNB 200), in other words, data that can be decoded by another cell (or a UE 100 located in another cell). It is noted that the data for a cell of the eNB 200, as an example, may include information indicating the position (such as the position of the slot and/or the subframe) of an ePDCCH transmitted by the cell and/or the subframe number (0 to 39). Further, the data for another cell may be load information of a cell of the eNB 200.

The eNB 200 may transmit either one of signals (a DRS or a Header) if the transmission timings of the DRS and the Header overlap. As described in [Appendix 3], the above-described method may be applied if the DRS and the Header structures are identical.

It is noted that the fourth embodiment may be applied to another embodiment.

### Fifth Embodiment

(Overview of Fifth Embodiment)

A base station according to a fifth embodiment includes a controller configured to transmit a Discovery Referencesignal (DRS) a plurality number of times in one downlink subframe.

In the fifth embodiment, the controller transmits one DRS in each slot of a plurality of slots in the one subframe.

In the fifth embodiment, a sequence of a secondary synchronization signal (SSS) included in the DRS transmitted by each slot, is configured to enable the user terminal to identify from which slot the DRS is transmitted.

In the fifth embodiment, if the number of times by which the DRS is repeatedly transmitted in the one subframe is equal to or more than a predetermined number of times, the controller transmits information indicating by which symbol the DRS to be transmitted is transmitted.

In the fifth embodiment, the information indicating by which symbol the DRS to be transmitted is transmitted, includes at least one of: information related to the number of repetitive transmissions, a symbol number, and a system frame number (SFN).

(Operation According to Fifth Embodiment)

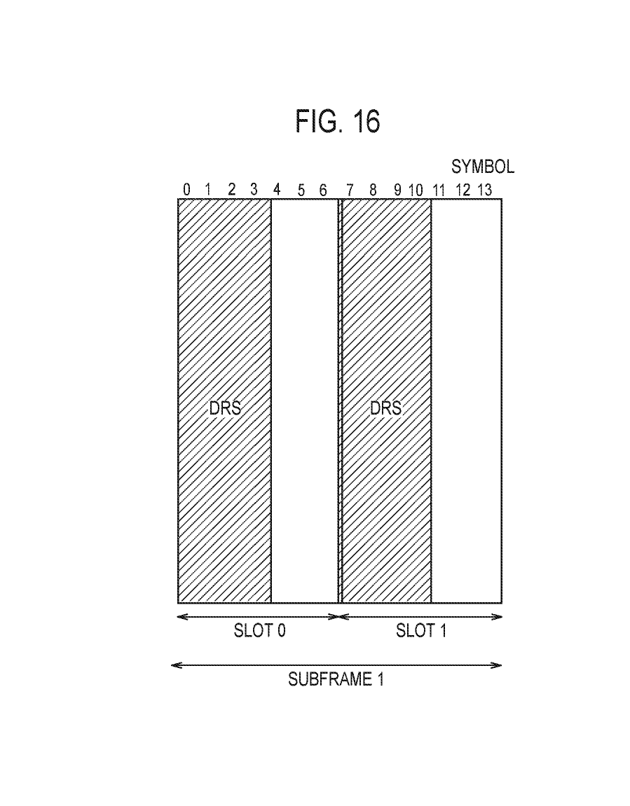

FIG. 16 is a diagram illustrating a DRS transmitted by the eNB 200 according to the fifth embodiment. It is noted that, as an example, one subframe is formed of two slots (slot 0 and slot 1), and one slot is formed of six symbols (OFDM symbols).

The eNB 200 uses a downlink subframe to transmit a DRS. As an example, the eNB 200 transmits a DRS a plurality number of times (for example, two times) in one subframe (subframe 1). As an example, the eNB 200 transmits one DRS for each slot (slot 0 and slot 1) in one subframe. It is noted that, as an example, in an unlicensed band, the DRS is a reference signal used to measure a radio resource management (RRM). Further, as an example, the DRS is formed of four symbols, and transmitted while being included into 0 to 3 symbol of each slot. It is noted that the DRS may be transmitted while being included into a symbol other than 0 to 3 symbol of each slot. Further, in one slot, a symbol other than a symbol including the DRS may include a PBCH and/or a PDSCH.

Moreover, the DRS may be formed of less than four symbols, and in this case, the eNB 200 may transmit DRSs while including two or more DRSs into one slot.

The UE 100 may evaluate by which slot (slot 0 or slot 1) the DRS was transmitted based on a sequence of the secondary synchronization signal (SSS) included in the DRS transmitted for each slot from the eNB 200.

In the one subframe, if the number of repetitive transmissions (repetitive number) of the DRS (identical DRS) is three or more, the eNB 200 may transmit the information indicating by which symbol the DRS to be transmitted is transmitted, to the UE 100. Here, the eNB 200 may transmit a message obtained by extending a discovery signals measurement timing configuration (DMTC) of an RRC message including the information indicating by which symbol the DRS to be transmitted. It is noted that the information indicating by which symbol the DRS to be transmitted is transmitted, includes at least one of a repetitive number, a symbol number (number of the symbol in which the DRS is transmitted; for example, 0 to 3 symbol) and a system frame number (SF) in which the DRS is transmitted. The repetitive number is the number of times that the DRS is repeatedly transmitted in the one subframe, and does not need to include the number of times that the same is transmitted in another subframe.

According to the fifth embodiment, an opportunity for the UE 100 to perform listen before talk (LBT) increases, and it is possible to increase synchronization accuracy between the eNB 200 and the UE 100.

### Sixth Embodiment

(Overview of Sixth Embodiment)

A base station according to a sixth characteristic includes a controller configured to perform a self-scheduling in an unlicensed band. The controller transmits scheduling information to a user terminal by using an enhanced physical downlink control channel (ePDCCH).

The base station according to the sixth embodiment includes a controller configured to perform a process of transmitting a header indicating positions of a plurality of enhanced PDCCHs (ePDCCHs) and transmitting the plurality of ePDCCHs along the positions of the plurality of ePDCCHs.

The base station according to the sixth embodiment includes a controller configured to perform a process of transmitting a header indicating the position of one ePDCCH, transmitting the one ePDDCH along the position of the one ePDDCH, and thereafter, transmitting another subsequent ePDCCH according to a predetermined principle.

(Operation According to Sixth Embodiment)

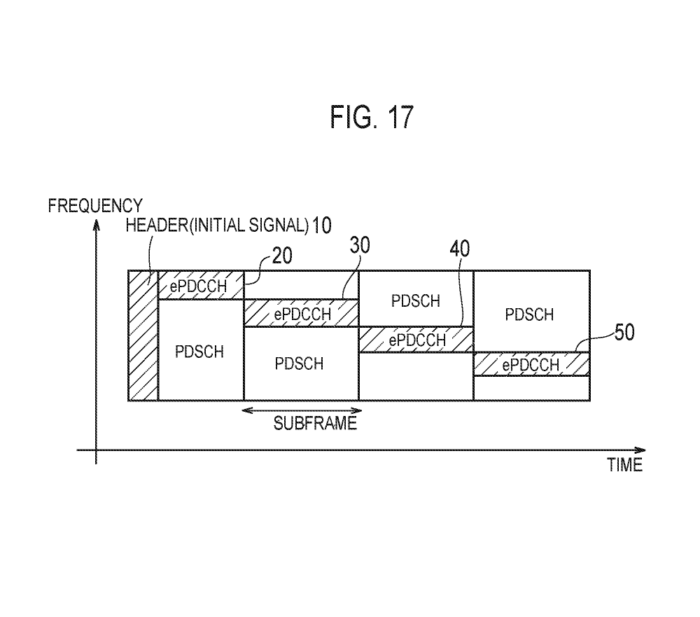

FIG. 17 is a diagram illustrating a transmission of the ePDCCH by the eNB 200 according to the sixth embodiment.

It is noted that the ePDCCH, as an example, is used for scheduling in the LAA. Further, the eNB 200 is not limited to transmitting to an ePDCCH 50 as illustrated in FIG. 17, and may further perform transmission subsequently to the ePDCCH 50.

First, the eNB 200 transmits the Header (or an Initial Signal) 10 in a predetermined subframe.

This Header (or Initial Signal) 10, as an example, is for synchronizing the eNB 200 and the UE 100, and may include information indicating how far the ePDCCH is continuously transmitted, a cell number (cell ID), and/or an operator number (operator ID).

This Header (or Initial Signal) 10 may include information indicating the position of the ePDCCH 20 that the eNB 200 transmits subsequently to the Header 10. Here, the information indicating the position of the ePDCCH 20 to be transmitted is, for example, the position of the subframe and/or the position of the resource block. After transmitting the ePDCCH 20 along the position of the ePDCCH 20 included in the Header 10, the eNB 200 may transmit ePDCCHs 30, 40, and 50 according to the predetermined principle.

FIG. 17 illustrates an example of the ePDCCHs 30, 40, and 50 transmitted subsequently to the ePDCCH 20 according to the principle.

Here, the predetermined principle may be, for example, that the eNB 200 transmits the next ePDCCH 30 with shifting by a predetermined resource blocks (RB) after transmitting the ePDDCH 20. Further, the predetermined principle may be obtained by a predetermined formula. It is noted that the principle may be set by the UE 100 and the eNB 200 in advance, and the UE 100 may be notified of the principle set by the eNB 200.

On the other hand, the Header (Initial Signal) 10 may include information indicating not only the position of the first ePDCCH 20 but also information indicating the positions of the subsequent ePDCCHs 30, 40, and 50. In this case, the eNB 200 transmits the ePDCCH along the positions of the ePDCCHs 30, 40, and 50 included in the Header (Initial Signal) 10. Therefore, the ePDCCH may not be transmitted according to the predetermined principle.

It is noted that if the DRS and the Initial Signal have the same structure, when the eNB and/or the UE transmits the Initial Signal, the effect similar to a case of transmitting the DRS is exhibited. For example, the UE realizes the RRM measurement by the Initial Signal.

### Seventh Embodiment

(Overview of Seventh Embodiment)

A base station according to a seventh embodiment performs radio communication with a user terminal in a specific frequency band shared by a plurality of operators and/or a plurality of communication systems. The base station includes a controller configured to perform a process of transmitting a first synchronization signal at a start timing of downlink transmission to the user terminal, and transmitting a second synchronization signal at a timing different from the start timing. The controller differentiates the signal configuration related to the first synchronization signal from the signal configuration related to the second synchronization signal.

In the seventh embodiment, the controller may differentiate a signal sequence of the first synchronization signal from the signal sequence of the second synchronization signal.

In the seventh embodiment, the first synchronization signal includes the first secondary synchronization signal, and the second synchronization signal includes the second secondary synchronization signal. The controller may differentiate the signal sequence of the first secondary synchronization signal from the signal sequence of the second secondary synchronization signal.

In the seventh embodiment, the controller may differentiate a resource arrangement pattern of the first synchronization signal from a resource arrangement pattern of the second synchronization signal.

In the seventh embodiment, the controller may set the number of the second synchronization signals in a frequency direction to a constant number, and set the number of the first synchronization signals in the frequency direction to the number in accordance with the transmission bandwidth.

In the seventh embodiment, the controller performs a process of transmitting a first reference signal associated with the first synchronization signal, and transmitting a second reference signal associated with the second synchronization signal. The controller may differentiate a resource arrangement pattern or a signal sequence of the first reference signal from that of the second reference signal.

A user terminal according to the seventh embodiment performs radio communication with a base station in a specific frequency band shared by a plurality of operators and/or a plurality of communication systems. The user terminal includes a controller configured to perform a process of receiving, from the base station, a first synchronization signal at a start timing of downlink transmission to the user terminal and receiving, from the base station, a second synchronization signal at a timing different from the start timing. A signal configuration related to the first synchronization signal is different from a signal configuration related to the second synchronization signal. The controller distinguishes, based on a difference of the signal configuration, between the first synchronization signal and the second synchronization signal.

The seventh embodiment will be described while focusing on the differences from the first embodiment to the sixth embodiment, below.

The eNB 200 according to the seventh embodiment performs the radio communication with the UE 100 in a specific frequency band shared by a plurality of operators and/or a plurality of communication systems. In the seventh embodiment, the specific frequency band is an unlicensed band. However, the specific frequency band may be a frequency band that requires a license (licensed band) and a frequency band shared by the plurality of operators and/or the plurality of communication systems.

The eNB 200 transmits a first synchronization signal at a start timing of downlink transmission to the UE 100, and transmits a second synchronization signal at a timing different from the start timing. In the seventh embodiment, the first synchronization signal is a synchronization signal included in an Initial Signal described later. The second synchronization signal is a synchronization signal included in a discovery reference signal (DRS). The eNB 200 differentiates a signal configuration related to the first synchronization signal from a signal configuration related to the second synchronization signal.

The UE 100 according to the seventh embodiment receives the first synchronization signal from the eNB 200 at the start timing of the downlink transmission to the UE 100, and receives the second synchronization signal from the eNB 200 at the timing different from the start timing. The signal configuration related to the first synchronization signal is different from the signal configuration related to the second synchronization signal. The UE 100 distinguishes, based on such difference of the signal configurations, between the first synchronization signal and the second synchronization signal.

(Operation of Downlink Transmission According to Seventh Embodiment)

The seventh embodiment is an embodiment in which LBT of a Load Based Equipment (LBE) scheme is mainly assumed. There are two schemes of the LBT, a Frame Based Equipment (FBE) scheme and a Load Based Equipment (LBE) scheme. The FBE scheme is a scheme in which a timing is fixed. On the other hand, a timing is not fixed in the LBE scheme.

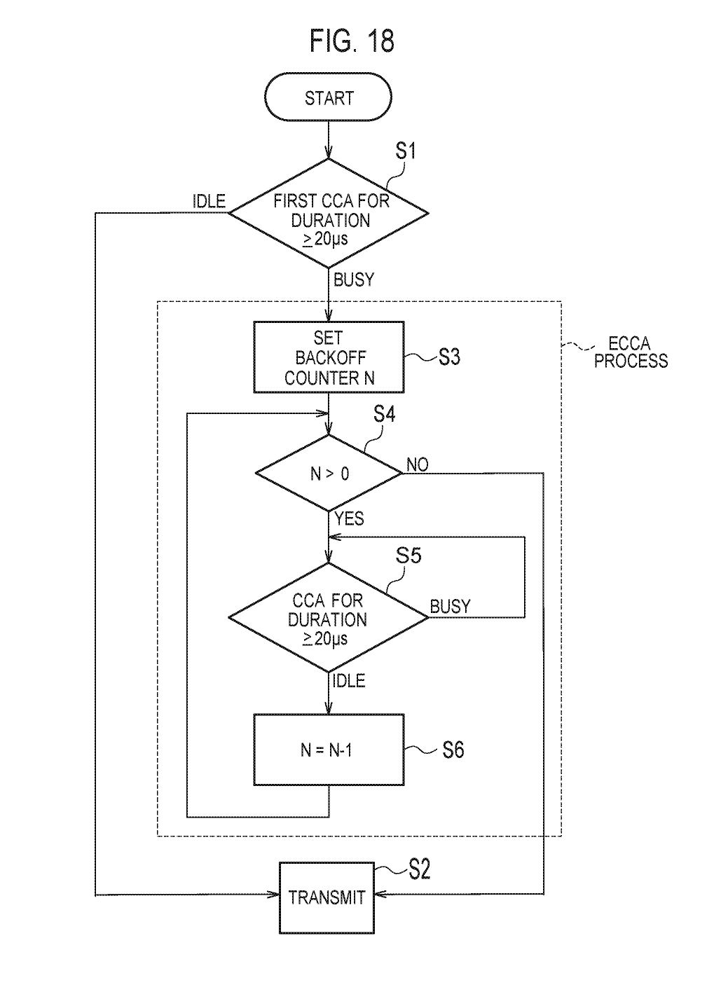

FIG. 18 is a flow chart illustrating an example of LBT of the LBE scheme.

As illustrated in FIG. 18, the eNB 200 monitors a target channel in an unlicensed band and determines, based on the received signal strength (interference power), whether or not the target channel is available (step S1). Such a determination is referred to as clear channel assessment (CCA). Specifically, if a state where the detected power is larger than a threshold value continues for a constant period (for example, 20 is or more), the eNB 200 determines that the target channel is in use (Busy). If the state does not continue for a constant period, then the eNB 200 determines that the target channel is available (Idle), and starts transmission (step S2).

As a result of such an initial CCA, if the target channel is determined to be in use (Busy), the eNB 200 transitions to an extended clear channel assessment (ECCA) process. In the ECCA process, the eNB 200 sets a counter (N) where the initial value is N (step S3). N is a random number between 4 and 32. The UE 100 decrements N (that is, subtracts 1) each time the CCA is successful (step S5 and step S6). Upon N reaching 0 (step S4: No), the eNB 200 determines that the target channel is available (Idle) and starts transmission (step S2).

In a case of such LBT of the LBE scheme, the eNB 200 can start the transmission not only upon starting the transmission from the head of the subframe, but also from a symbol interval in the middle of the subframe.

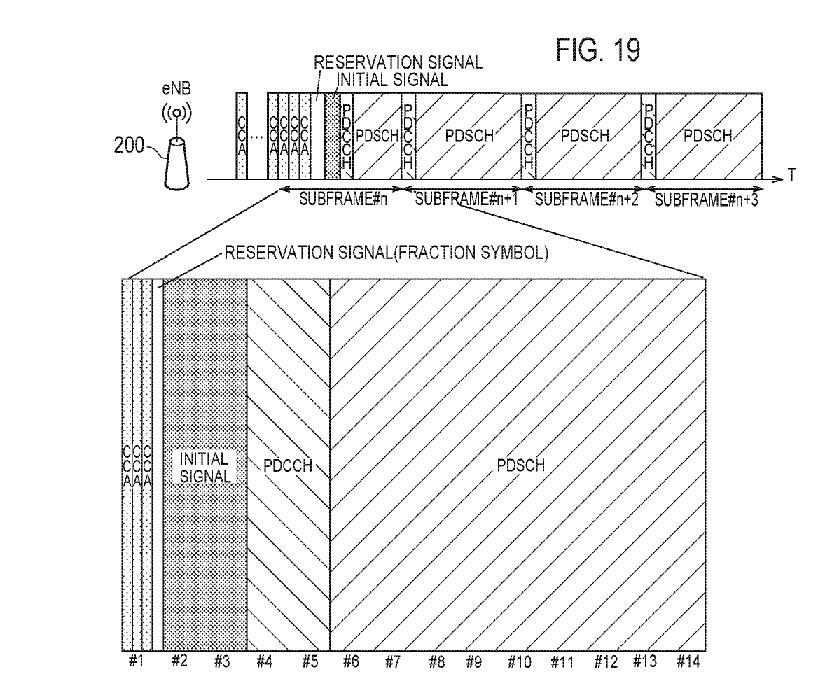

FIG. 19 is a diagram for describing the downlink transmission operation according to the seventh embodiment.

As illustrated in FIG. 19, the eNB 200 starts the downlink transmission after successfully performing the LBT. FIG. 19 illustrates an example of the eNB 200 successfully performing the LBT in the middle of the head symbol interval #1 of subframe #n. In this case, the eNB 200 performs the transmission in the order of a Reservation Signal, the Initial Signal, the control signal (PDCCH), and the data (PDSCH).

The Reservation Signal is a signal for occupying the target channel up to a point of starting the next symbol interval, so that another device does not interrupt the target channel if the CCA completion of the end of the LBT is in the middle of the symbol interval. The Reservation Signal, for example, may be used as a cyclic prefix (CP) of the Initial Signal.

The Initial Signal is a signal for notifying the UE 100 of the start timing of the downlink transmission. FIG. 19 illustrates an example of the Initial Signal having a time length of two symbol intervals. However, the Initial Signal may be a time length of one symbol interval. The Initial Signal includes a first synchronization signal. The first synchronization signal includes a primary synchronization signal (PSS) and a secondary synchronization signal (SSS). The eNB 200 transmits the first synchronization signal at the start timing of the downlink transmission to the UE 100 (symbol interval #2 and symbol interval #3).

Further, the eNB 200 transmits the DRS as described above. The DRS is a signal used to establish synchronization and to measure the downlink. The DRS includes a second synchronization signal that the UE 100 uses to establish the downlink synchronization. The second synchronization signal includes the PSS and the SSS. Further, the DRS includes a cell-specific reference signal (CRS) used by the UE 100 for measuring the downlink. A general synchronization signal may be applied to the second synchronization signal. Specifically, the second synchronization signal is arranged in a resource block located in the central portion of the downlink transmission frequency band. Further, the second synchronization signal is arranged in a previously defined subframe. Alternatively, the second synchronization signal may be arranged in any subframe. In this case, the DRS may include information of the subframe number in which the second synchronization signal is arranged.

(Method of Distinguishing Initial Signal and DRS)

As described above, both of the Initial Signal and the DRS include the synchronization signal (PSS/SSS). However, if the signal configurations of the first synchronization signal included in the Initial Signal and the second synchronization signal included in the DRS are the same, the UE 100 that received the synchronization signal can not distinguish which of the Initial Signal and the DRS the synchronization signal corresponds to. If the UE 100 cannot recognize the Initial Signal, the UE 100 cannot suitably recognize the downlink transmission timing for the UE 100.

Therefore, the eNB 200 according to the seventh embodiment differentiates the signal configuration related to the first synchronization signal included in the Initial Signal from the signal configuration related to the second synchronization signal included in the DRS. The UE 100 distinguishes, based on such difference of the signal configurations, between the first synchronization signal and the second synchronization signal. Thereby, the UE 100 can suitably recognize the downlink transmission timing to the UE 100.

(1) First Method

First, a first method of distinguishing between the Initial Signal (first synchronization signal) and the DRS (second synchronization signal) will be described.

In the first method, the eNB 200 differentiates the signal sequence of the first synchronization signal from the signal sequence of the second synchronization signal. For example, the eNB 200 differentiates the signal sequence of the SSS (first SSS) included in the first synchronization signal from the signal sequence of the SSS (second SSS) included in the second synchronization signal. The signal sequence that can be used as the first SSS and the signal sequence that can be used as the second SSS may be previously defined. Upon receiving the SSS, based on the signal sequence of the received SSS, the UE 100 distinguishes which of the Initial Signal and the DRS the signal including the SSS corresponds to.

(2) Second Method

Next, a second method of distinguishing the Initial Signal (first synchronization signal) from the DRS (second synchronization signal) will be described.

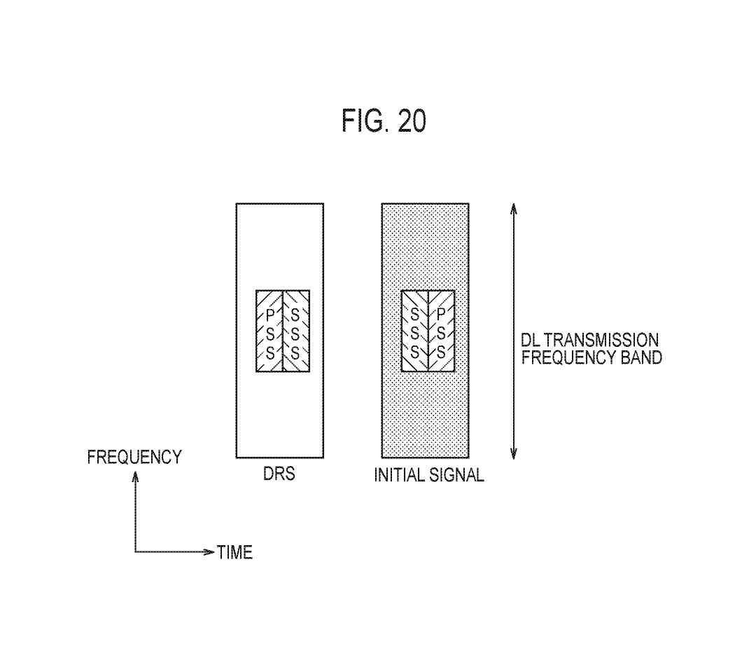

In the second method, the eNB 200 differentiates a resource arrangement pattern of the first synchronization signal from a resource arrangement pattern of the second synchronization signal. FIG. 20 is a diagram for describing the second method. As illustrated in FIG. 20, in the DRS (second synchronization signal), the symbol interval of the SSS is provided after the symbol interval of the PSS. On the other hand, in the Initial Signal (first synchronization signal), the symbol interval of the PSS is provided after the symbol interval of the SSS. Conversely, in the DRS (second synchronization signal), the symbol interval of the PSS may be provided after the symbol interval of the SSS, and in the Initial Signal (first synchronization signal), the symbol interval of the SSS may be provided after the symbol interval of the PSS. Upon receiving the PSS and the SSS, the UE 100 distinguishes, based on a positional relationship between the PSS and the SSS in the time direction, which of the Initial Signal or the DRS the received signal including the PSS and SSS corresponds to.

Further, instead of differentiating the resource arrangement pattern in the time direction for the first synchronization signal and the second synchronization signal, the resource arrangement pattern may be differentiated in the frequency direction. For example, the position (arrangement) on the frequency axis is differentiated between the first synchronization signal and the second synchronization signal.

(3) Third Method

Next, a third method of distinguishing the Initial Signal (first synchronization signal) from the DRS (second synchronization signal) will be described.

In the third method, the eNB 200 transmits the first reference signal accompanied with the first synchronization signal, and transmits the second reference signal accompanied with the second synchronization signal. The eNB 200 differentiates the resource arrangement pattern of the first reference signal from the resource arrangement pattern of the second reference signal. Alternatively, the eNB 200 may differentiate the signal sequence of the first reference signal from the signal sequence of the second reference signal. The first reference signal is a reference signal included in the Initial Signal, for example, a CRS or a DMRS for demodulation of the PDSCH. On the other hand, the second reference signal is a reference signal included in the DRS, for example, a CRS for the downlink measurement (RRM measurement). Upon receiving the synchronization signal and the reference signal accompanied therewith, the UE 100 distinguishes, based on the resource arrangement pattern (resource mapping) of the reference signal or the signal sequence, which of the Initial Signal and the DRS the received signal including the synchronization signal corresponds to.

(Relationship Between Synchronization Signal and Transmission Bandwidth)

A relationship between a synchronization signal and a transmission bandwidth will be described, below.

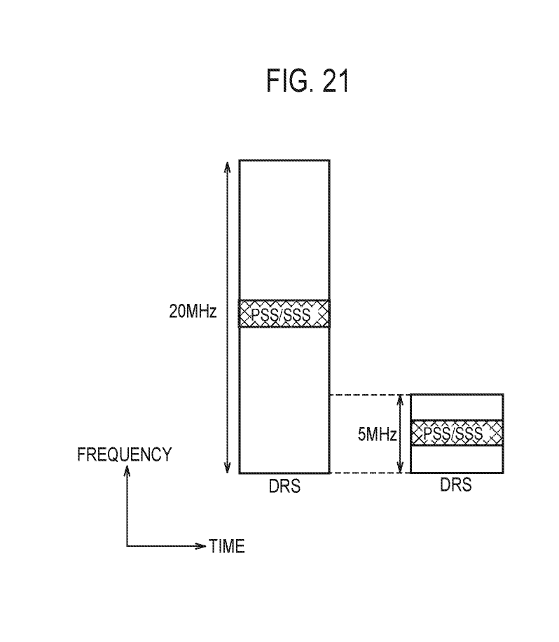

In the DRS, the eNB 200 sets the number of the second synchronization signals in the frequency direction to a constant number. FIG. 21 is a diagram illustrating an example of the second synchronization signal. As illustrated in FIG. 21, the eNB 200 arranges the second synchronization signal (PSS/SSS) only in the central portion of the downlink transmission frequency band.

On the other hand, with regard to the Initial Signal, the eNB 200 sets a number of the first synchronization signals in the frequency direction to a number in accordance with the bandwidth of the downlink transmission frequency band (downlink transmission bandwidth). Specifically, as the downlink transmission bandwidth is wider, the eNB 200 increases the number of the first synchronization signals in the frequency direction. Thereby, the Initial Signal (first synchronization signal) can entirely occupy the downlink transmission frequency band. Therefore, in an Initial Signal period, it is possible to avoid another device from interrupting a portion of the downlink transmission frequency band. It is noted that if receiving a plurality of synchronization signal arranged in the frequency direction, the UE 100 may recognize that a signal including the synchronization signals corresponds to the Initial Signal.

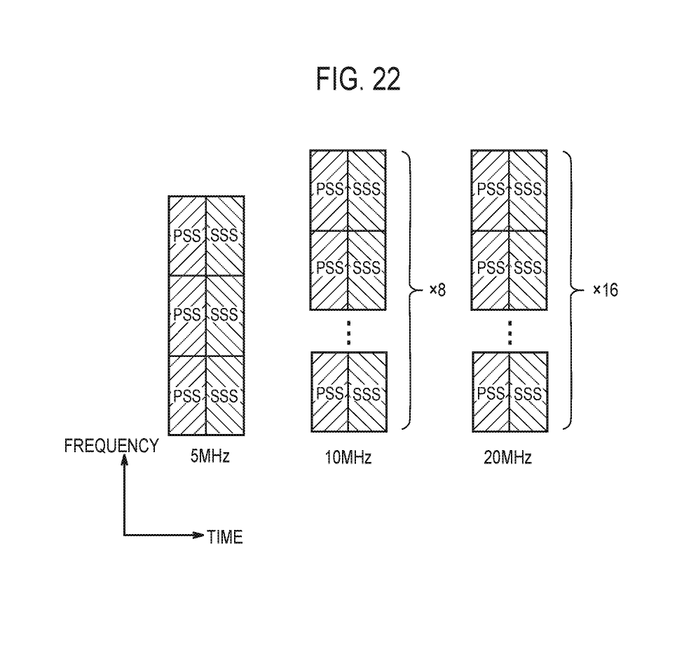

FIG. 22 is a diagram illustrating an example of the first synchronization signal. As illustrated in FIG. 22, the eNB 200 increases the number of the first synchronization signals in the frequency direction as the downlink transmission bandwidth is wider. For example, if the downlink transmission bandwidth is 1.4 MHz, the eNB 200 arranges one synchronization signal (PSS/SSS) in the frequency direction. If the downlink transmission bandwidth is 3.0 MHz, the eNB 200 arranges two synchronization signals (PSSs/SSSs) in the frequency direction. If the downlink transmission bandwidth is 5.0 MHz, the eNB 200 arranges three synchronization signals (PSSs/SSSs)in the frequency direction. If the downlink transmission bandwidth is 10 MHz, the eNB 200 arranges eight synchronization signals (PSSs/SSSs) in the frequency direction. If the downlink transmission bandwidth is 20 MHz, the eNB 200 arranges 16 synchronization signals (PSSs/SSSs) in the frequency direction.

It is noted that if the downlink transmission bandwidth has an available resource (available resource element) in which a first synchronization signal is not arranged, the eNB 200 may arrange the control information in the available resource and may arrange nothing (be blank) in the available resource.

(Modification of Seventh Embodiment)

In the seventh embodiment, the LBT of the LBE scheme is described, but LBT of the FBE scheme may also be used.

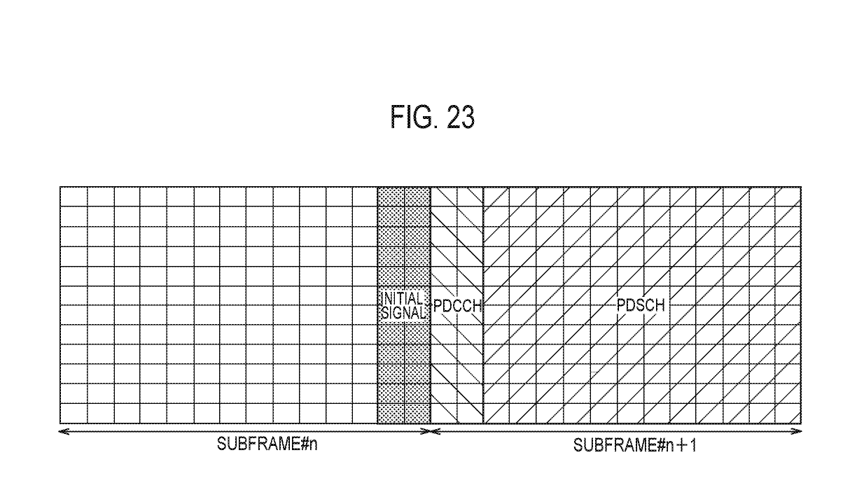

Further, in the seventh embodiment, an example of transmitting the Initial Signal and the data in the same subframe is described. However, as illustrated in FIG. 23, the Initial Signal may be transmitted in a subframe different from the subframe that the data (PDSCH) is transmitted.

### Eighth Embodiment

(Overview of Eighth Embodiment)

A radio communication apparatus according to an eighth embodiment performs radio communication in a specific frequency band shared by a plurality of operators and/or a plurality of communication systems. The radio communication apparatus includes a controller configured to perform, if the radio communication is performed over the plurality of subframes, a process of transmitting number-of-subframes information in a target subframe out of the plurality of subframes. The number-of-subframes information is information related to the number of subframes subsequent to the target sub frame, out of the plurality of sub frames.

In the eighth embodiment, if transmission is performed over a transmission period formed of a plurality of consecutive subframes, the controller performs a process of transmitting the number-of-subframes information in the target subframe, out of the plurality of consecutive subframes.

In the eighth embodiment, the number-of-subframes information indicates a number of subframes corresponding to a remaining transmission period.

In the eighth embodiment, if performing the transmission over the transmission period formed of the plurality of consecutive subframes, and thereafter, performing reception over a reception period formed of at least one subframe, the controller performs a process of transmitting the number-of-subframes information in the target sub frame, out of the plurality of consecutive subframes.

In the eighth embodiment, the number-of-subframes information indicates the number of the subframes until the reception period starts.

In the eighth embodiment, the number-of-subframes information indicates the number of subframes until the reception period ends.

In the eighth embodiment, if there is a time interval between the transmission period and the reception period, the controller performs a process of further transmitting information indicating the time interval.

In the eighth embodiment, the target subframe includes a first subframe out of the plurality of consecutive subframes.

In the eighth embodiment, the target subframe includes a subframe other than the first subframe out of the plurality of consecutive subframes.

The radio communication apparatus according to the eighth embodiment performs radio communication in the specific frequency band shared by the plurality of operators and/or the plurality of communication systems. The radio communication apparatus includes a controller configured to perform, if another radio communication apparatus performs radio communication in the specific frequency band over a plurality of subframes, a process of receiving number-of-subframes information from the other radio communication apparatus in a target subframe out of the plurality of subframes. The number-of-subframes information is information related to the number of subframes subsequent to the target subframe, out of the plurality of subframes. The controller stops an operation of monitoring the specific frequency band, based on the number-of-subframes information.

The eighth embodiment will be described while focusing on the differences from the first embodiment to the seventh embodiment, below.

(Operation According to Eighth Embodiment)

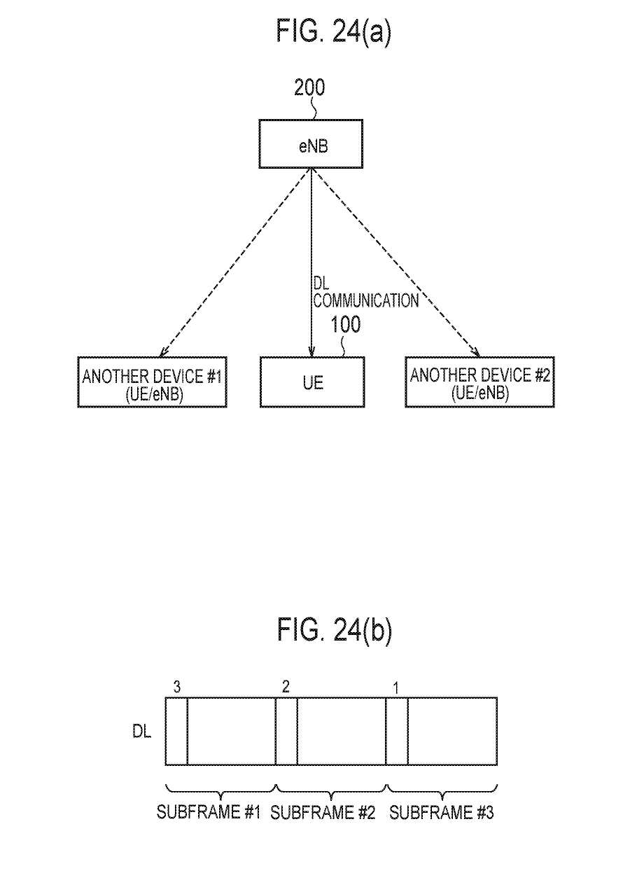

FIGS. 24(a) and 24(b) are diagrams for describing an operation according to an eighth embodiment.

As illustrated in FIG. 24(a), the eNB 200 according to the eighth embodiment performs radio communication in a specific frequency band shared by a plurality of operators and/or a plurality of communication systems. FIG. 24(a) illustrates an example of the eNB 200 performing downlink communication (DL communication) with the UE 100. In the eighth embodiment, the specific frequency band is an unlicensed band. However, the specific frequency band may be a frequency band that requires a license (licensed band) and a frequency band shared by the plurality of operators and/or the plurality of communication systems.

The eNB 200 according to the eighth embodiment transmits number-of-subframes information in a target subframe out of a plurality of subframes, if performing radio communication over the plurality of subframes. The number-of-subframes information is information related to the number of subframes subsequent to the target subframe out of the plurality of sub frames.

As illustrated in FIG. 24(b), if performing transmission over a transmission period formed of a plurality of consecutive subframes (subframes #1 to #3), the eNB 200 performs a process of transmitting the number-of-subframes information in the target subframe out of the plurality of consecutive subframes. The number-of-subframes information indicates the number of subframes corresponding to a remaining transmission period. However, the number-of-subframes information may be information indicating the number of subframes in which at least the transmission is continued. If subframe information is transmitted by using a physical control format indicator channel (PCFICH) as described later, the number of bits that can be transmitted is small (for example, 2 bits). Therefore, if the transmission continues over a large number of subframes, the numbers of all the subframes corresponding to a remaining transmission period cannot be represented. Specifically, if an assumption is made that 2-bit subframe information is included in the PCFICH, a maximum number of subframes that can be notified by the subframe information is three subframes. Therefore, until there are only two subframes left to an end of the transmission period, the subframe information may notify to the effect that “transmission continues for at least three subframes”.

In the eighth embodiment, the target subframe includes the first subframe out of the plurality of consecutive subframes. Further, the target subframe includes subframes other than the first subframe out of the plurality of consecutive subframes.

In the example illustrated in FIG. 24(b), in the first subframe #1, the eNB 200 transmits the subframe information indicating “3” being the number of subframes corresponding to the remaining transmission period. Further, in the second subframe #2, the eNB 200 transmits the subframe information indicating “2” being the number of subframes corresponding to the remaining transmission period. Further, in the third subframe #3, the eNB 200 transmits the subframe information indicating “1” being the number of subframes corresponding to the remaining transmission period. It is noted that in the above described examples, although the number of subframes included in the subframe information is calculated while also including the currently transmitted subframe into the number; this is not always the case, and the number of subframes may be calculated while not including the currently transmitted subframe into the number.

In the eighth embodiment, in each of the consecutive subframes #1 to #3, the eNB 200 transmits the physical control format indicator channel (PCFICH) including the subframe information. The PCFICH is arranged in the head symbol interval of the downlink subframe. The general PCFICH transports information indicating the number of symbols configuring the PDCCH interval. In the eighth embodiment, instead of the information on the number of symbols configuring the PDCCH interval, the PCFICH transports the subframe information. In this case, the number of symbols in the PDCCH interval is fixed to any numbers from one to three so that the information on the number of symbols configuring the PDCCH interval becomes unnecessary. Thereby, the PCFICH can transport the subframe information.

Alternatively, in addition to the information on the number of symbols configuring the PDCCH interval, the PCFICH may transport the subframe information. In this case, in order to include both information, a new PCFICH having a larger information amount than the existing PCFICH may be defined.

The eNB 200 may transmit the PDCCH (control signal) including the subframe information. It is possible to include a plurality of pieces of DCI in a PDCCH region, and thus, upon separating a PDCCH for the UE 100 (DCI) and a PDCCH for another device (DCI), the UE 100 and the other device can receive the subframe information. Instead of using such individual DCI, by using an RNTI (such as shared information-RNTI (SI-RNTI), for example) common to a plurality of devices including the UE 100, one piece of DCI may be transmitted to the plurality of devices.

Alternatively, instead of the PDCCH, an enhanced PDCCH (ePDCCH) may be used. Further, the eNB 200 may transmit the header signal including the subframe information. The eNB 200 may transmit the downlink broadcast signal including the subframe information.

The UE 100 receives the subframe information that the eNB 200 transmits in each of the consecutive subframes from #1 to #3, and the UE 100 can understand, based on the subframe information, the remaining transmission period of the eNB 200.

Further, devices other than the UE 100 configured to perform the downlink communication with the eNB 200 also receive the subframe information. In FIG. 24(a), other devices #1 and #2 are illustrated as another radio communication apparatus configured to perform radio communication in the unlicensed band. The other devices #1 and #2 are a radio communication apparatus by the same operator as that of the eNB 200 and the UE 100. However, the other devices #1 and #2 may be a radio communication apparatus by an operator different from that of the eNB 200 and the UE 100. Each of the other devices #1 and #2 may be an eNB or a UE.

Each of the other devices #1 and #2 receives the subframe information from the eNB 200 and understands, based on the number-of-subframes information, the remaining transmission period (that is, channel occupancy period) of the eNB 200. Further, in the remaining transmission period of the eNB 200, each of the other devices #1 and #2 stops the operation of monitoring the unlicensed band (that is, LBT). In this manner, while the eNB 200 and the UE 100 continue the downlink communication, the other devices #1 and #2 suspend the LBT (CCA) to reduce processing load and power consumption of the other devices #1 and #2.

In particular, the eNB 200 also transmits the subframe information in a subframe other than the first subframe #1 (subframe #2 and subframe #3) of the plurality of consecutive subframes #1 to #3. Thereby, the other devices #1 and #2 can receive the subframe information in any one of the subframes #2 and #3, even if failing in the reception of the subframe information in the first subframe #1. As a result, even if the subframe information in any of the subframes #1 to #3 is received, it is possible to understand how many subframes need to pass to release the transmission. It is noted that if the subframe information is further received after receiving the subframe information from the eNB 200, another device (UE/eNB) may determine (modify) a monitoring duration, based on the subframe information received most recently.

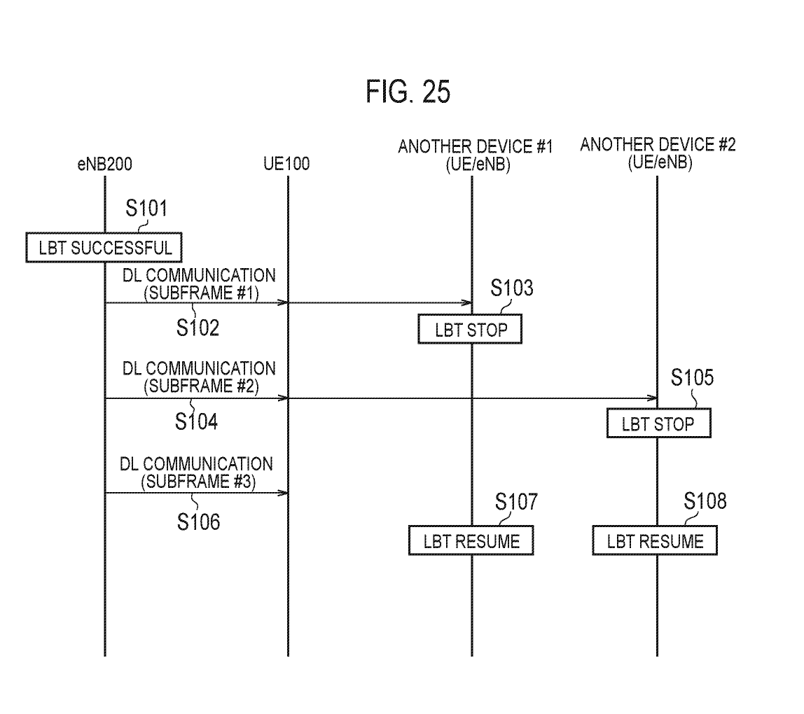

FIG. 25 is a sequence diagram illustrating an example of an operation according to the eighth embodiment. Here, an example where the transmission period of the eNB 200 (channel occupancy period) is three subframes will be described.

As illustrated in FIG. 25, the eNB 200 succeeds in LBT (S101), and starts the transmission (including PDSCH transmission) to the UE 100 in subframe #1 (S102). Here, the eNB 200 transmits subframe information indicating the number of subframes “3” corresponding to a remaining transmission period. In the subframe #1, the UE 100 receives a control signal and data from the eNB 200. In the subframe #1, the UE 100 may receive subframe information from the eNB 200. Further, in the subframe #1, another device #1 receives the subframe information. The other device #1 stops the LBT, based on the subframe information (S103).

Next, in subframe #2, the eNB 200 performs transmission (including PDSCH transmission) to the UE 100 (S104). Here, the eNB 200 transmits subframe information indicating the number of subframes “2” corresponding to a remaining transmission period. In the subframe #2, the UE 100 receives a control signal and data from the eNB 200. In the subframe #2, the UE 100 may receive the subframe information from the eNB 200. Further, in the subframe #2, another device #2 receives the subframe information. The other device #2 stops the LBT, based on the subframe information (S105).

Next, in subframe #3, the eNB 200 performs transmission (including PDSCH transmission) to the UE 100 (S106). Here, the eNB 200 transmits subframe information indicating the number of subframes “1” corresponding to a remaining transmission period. In the subframe #3, the UE 100 receives a control signal and data from the eNB 200. In the subframe #3, the UE 100 may receive the subframe information from the eNB 200.

Further, each of the other devices #1 and #2 resumes, based on the subframe information, the LBT after the subframe #3 passes through (S107 and S108).

It is noted that in the present sequence, an example where the transmission period of the eNB 200 (channel occupancy period) is three subframes is described above. However, the eNB 200 may modify the transmission period after starting the transmission. For example, the eNB 200 may modify the transmission period to four subframes or two subframes after S102. In this case, in S104 and S106, the eNB 200 transmits the subframe information, based on the modified transmission period.

(Modification of Eighth Embodiment)

In a first modification and a second modification of the eighth embodiment, after performing transmission over a transmission period (DL period) formed of a plurality of consecutive subframes, the eNB 200 performs reception over a reception period (UL period) formed of at least one subframe. The eNB 200 transmits number-of-subframes information in a target subframe during the transmission period.

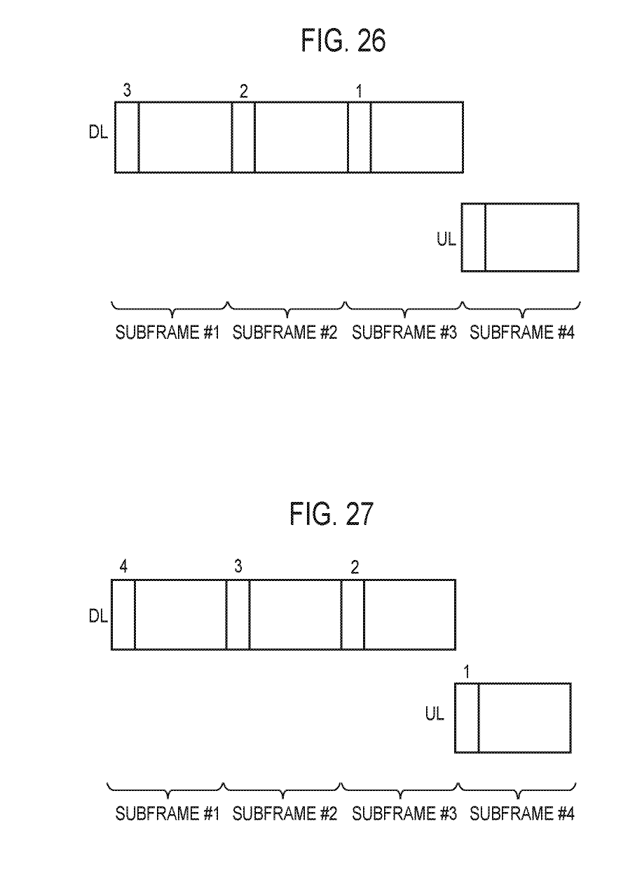

The first modification of the eighth embodiment will be described. In the first modification of the eighth embodiment, the number-of-subframes information indicates the number of subframes until the reception period (UL period) starts. FIG. 26 is a diagram for describing an operation according to the first modification of the eighth embodiment. As illustrated in FIG. 26, after performing transmission to the UE 100 over a transmission period (DL period) formed of a plurality of consecutive subframes #1 to #3, the eNB 200 performs reception from the UE 100 over a reception period (UL period) formed of subframe #4. In each of the subframes #1 to #3, the eNB 200 transmits the number-of-subframes information that indicates the number of subframes until the reception period (UL period) starts.

In the example illustrated in FIG. 26, in the first subframe #1, the eNB 200 transmits the subframe information that indicates the number of subframes “3” until the reception period (UL period) starts. Further, in the second subframe #2, the eNB 200 transmits the subframe information that indicates the number of subframes “2” until the reception period (UL period) starts. Moreveover, in the third subframe #3, the eNB 200 transmits the subframe information that indicates the number of subframes “1” until the reception period (UL period) starts.

Next, the second modification of the eighth embodiment will be described. In the second modification of the eighth embodiment, the number-of-subframes information indicates the number of subframes until the transmission period (DL period) and the reception period (UL period) ends.

FIG. 27 is a diagram for describing an operation according to the second modification of the eighth embodiment. As illustrated in FIG. 27, after performing transmission to the UE 100 over the transmission period (DL period) formed of the plurality of consecutive subframes #1 to #3, the eNB 200 performs reception from the UE 100 over the reception period (UL period) formed of the subframe #4. In each of the subframes #1 to #3, the eNB 200 transmits the number-of-subframes information that indicates the number of subframes (that is, all periods of the transmission period and the reception period) until the reception period (UL period) ends.

In the example illustrated in FIG. 27, in the first subframe #1, the eNB 200 transmits the subframe information that indicates the number of subframes “4” until the reception period (UL period) ends. Further, in the second subframe #2, the eNB 200 transmits the subframe information that indicates the number of subframes “3” until the reception period (UL period) ends. Moreover, in the third subframe #3, the eNB 200 transmits the subframe information that indicates the number of subframes “2 ” until the reception period (UL period) ends. In addition, in the fourth subframe #4, the UE 100 transmits the subframe information indicating the number of subframes “1” until the reception period (UL period) ends (in the fourth subframe #4, the eNB 200 receives subframe information indicating the number of subframes “1” until the reception period (UL period) ends). It is noted that the UE 100 may transmit the subframe information by using the PUCCH or the PUSCH, for example. The subframe information transmitted by the UE 100 may be received by the other devices (#1 and #2). However, in the fourth subframe #4, the eNB 200 may transmit the subframe information that indicates the number of subframes “1” until the reception period (UL period) ends.

It is noted that FIG. 26 and FIG. 27 illustrate examples of the consecutive transmission period (DL period) and the reception period (UL period). However, the transmission period and the reception period may not be consecutive. If there is a time interval between the transmission period and the reception period, the eNB 200 transmit the information indicating the time interval together with the subframe information. The time interval, for example, is expressed in the number of subframes.

### Ninth Embodiment

(Overview of Ninth Embodiment)

A radio communication apparatus according to a ninth embodiment performs radio communication in a specific frequency band shared by a plurality of operators and/or a plurality of communication systems. The radio communication apparatus includes a controller configured to perform, if starting transmission from a target symbol interval of a subframe including a plurality of symbol intervals, a process of transmitting number-of-symbols information in the target symbol interval. The number-of-symbols information is information related to the number of symbol intervals subsequent to the target symbol interval out of the plurality of symbol intervals.

In the ninth embodiment, the controller performs a process of transmitting an Initial Signal including the number-of-symbols information, the Initial Signal indicating start of transmission to another radio communication apparatus. The number-of-symbols information is information related to the number of symbol intervals for data transmission, out of the plurality of symbol intervals.

In the ninth embodiment, the target symbol interval includes a symbol interval other than the first symbol interval out of the plurality of symbol intervals.

The ninth embodiment will be described while focusing on the differences from the first embodiment to the eighth embodiment, below. The ninth embodiment is an embodiment in which LBT of a Load Based Equipment (LBE) scheme is mainly assumed.

(Operation According to Ninth Embodiment)

There are two schemes of the LBT, a Frame Based Equipment (FBE) scheme and a Load Based Equipment (LBE) scheme. The FBE scheme is a scheme in which a timing is fixed. On the other hand, a timing is not fixed in the LBE scheme.

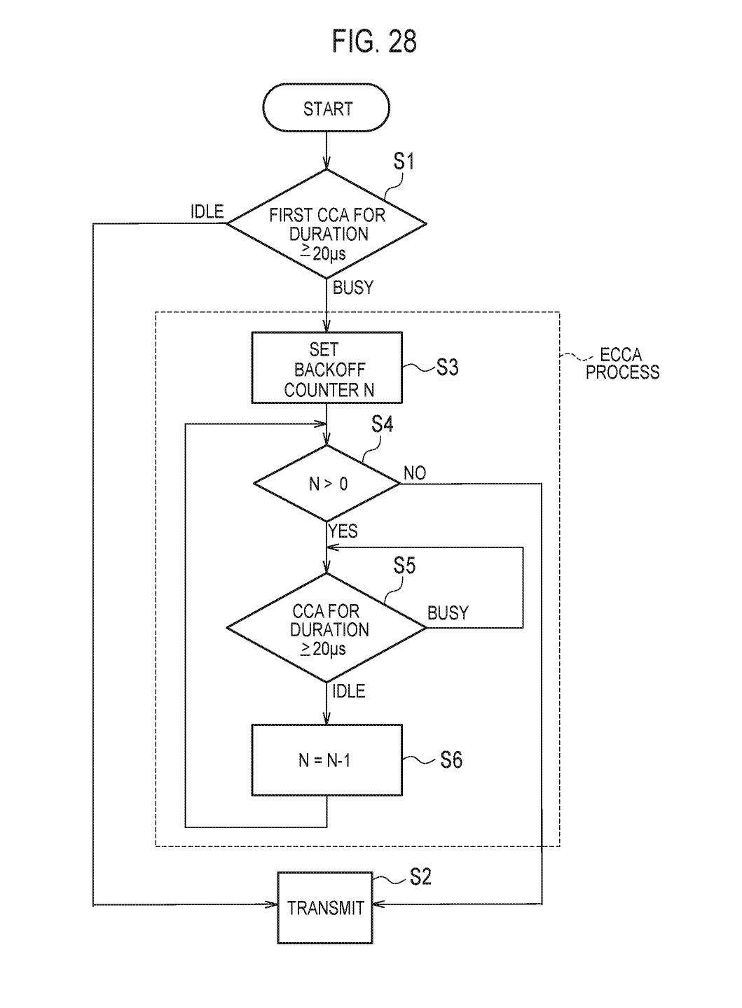

FIG. 28 is a flow chart illustrating an example of the LBT of the LBE scheme. The UE 100 and the eNB 200 execute the present flow for a target channel in an unlicensed band. Here, an example of the eNB 200 executing the present flow will be described.

As illustrated in FIG. 28, the eNB 200 monitors the target channel and determines, based on the received signal strength (interference power), whether or not the target channel is available (step S1). Such a determination is referred to as clear channel assessment (CCA). Specifically, if a state where the detected power is larger than a threshold value continues for a constant period (for example, 20 is or more), the eNB 200 determines that the target channel is in use (Busy). Otherwise, the eNB 200 determines that the target channel is available (Idle), and transmits downlink data to the UE 100 by using the target channel (step S2).

As a result of such an initial CCA, if the target channel is determined to be in use (Busy), the eNB 200 transitions to an extended clear channel assessment (ECCA) process. In the ECCA process, the eNB 200 sets a counter (N) where the initial value is N (step S3). N is a random number between 4 and 32. The UE 100 decrements N (that is, subtracts 1) each time the CCA is successful (step S5 and step S6). Upon N reaching 0 (step S4: No), the eNB 200 determines that the target channel is available (Idle) and transmits a radio signal by using the target channel (step S2).

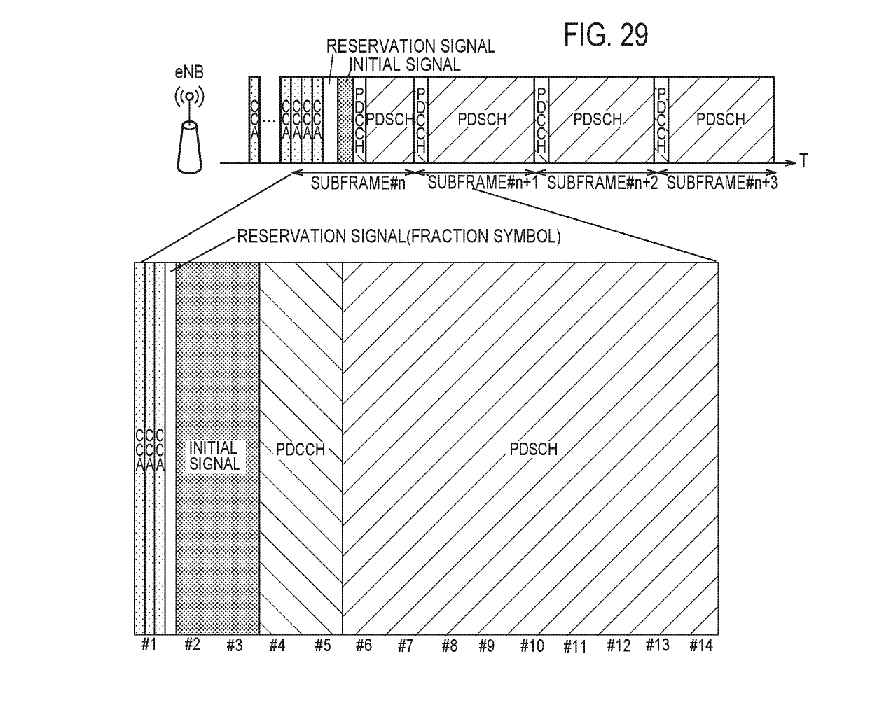

In a case of such LBT of the LBE scheme, the eNB 200 can start the transmission not only upon starting the transmission from the head of the subframe, but also from a symbol interval in the middle of the subframe. FIG. 29 is a diagram for describing a DL transmission operation according to the ninth embodiment.

As illustrated in FIG. 29, the eNB 200 starts DL transmission after successfully performing the LBT. FIG. 29 illustrates an example of the eNB 200 successfully performing the LBT in the middle of the head symbol interval #1 of subframe #n. The eNB 200 performs the transmission in the order of a Reservation Signal, the Initial Signal, the control signal (PDCCH), and the data (PDSCH).

The Reservation Signal is a signal for occupying the target channel up to a point of starting the next symbol interval, so that another device does not interrupt the target channel if the CCA completion of the end of the LBT is in the middle of the symbol interval. The Reservation Signal, for example, may be used as a cyclic prefix (CP) of the Initial Signal.

The Initial Signal is a signal for notifying the UE 100 of the start timing of the data transmission. In the ninth embodiment, the Initial Signal includes predetermined control information and a synchronization signal (PSS/SSS). In the ninth embodiment, the predetermined control information includes the number-of-symbols information. The predetermined control information may include the subframe information described in the eighth embodiment.

The eNB 200 according to the ninth embodiment starts transmission (that is, transmits an Initial Signal) to the UE 100 from target symbol intervals (symbol intervals #2 and #3) of the subframe formed of a plurality of symbol intervals (symbol intervals #1 to #14). In this case, the Initial Signal including the number-of-symbols information is transmitted in the target symbol intervals. The number-of-symbols information is information related to the number of symbol intervals subsequent to the target symbol intervals (symbol intervals #2 and #3) of the plurality of symbol intervals (symbol intervals #1 to #14).

Thereby, even if the UE 100 receives the Initial Signal in a symbol interval other than the first symbol interval, the UE 100 can understand, based on the number-of-symbols information, the number of the remaining symbol intervals in the subframe. Therefore, the UE 100 can suitably perform the data reception.

The number-of-symbols information may be information indicating the number of symbol intervals corresponding to intervals for the data transmission (PDSCH intervals). In an example of FIG. 29, the eNB 200 transmits the Initial Signal, to the UE 100, including the number-of-symbols information indicating the symbol interval number “9 ” corresponding to the PDSCH intervals (symbol intervals #6 to #14).

Alternatively, the number-of-symbols information may be information indicating the symbol interval number corresponding to the total numbers of the PDCCH intervals and the PDSCH intervals. In the example of FIG. 29, the eNB 200 transmits the Initial Signal, to the UE 100, including the number-of-symbols information indicating the symbol interval number “11” corresponding to the total number of the PDCCH intervals and the PDSCH intervals (symbol intervals #4 to #14).

Alternatively, the number-of-symbols information may be information that identifies the target symbol intervals (symbol intervals #2 and #3) in which the Initial Signal is transmitted. In the example of FIG. 29, the eNB 200 transmits in the Initial Signal including the symbol numbers of the target symbol intervals (symbol intervals #2 and #3) in which the Initial Signal is transmitted and transmits the signal to the UE 100.

### Other Embodiments

The first embodiment to the ninth embodiment described above are not limited to a case of being separately and independently implemented. Two or more embodiments of the first embodiment to the ninth embodiment may be executed in combination.

In the first embodiment to the ninth embodiment described above, uplink communication is not specifically mentioned. However, the operation according the first embodiment to the ninth embodiment (especially the eighth embodiment and the ninth embodiment) can be also applied to the uplink communication. For example, in the eighth embodiment and the ninth embodiment, the eNB 200 may be replaced with the UE 100 and the UE 100 may be replaced with the eNB 200.

In the first embodiment to the ninth embodiment described above, examples where the identical eNB 200 managing the cell #1 (licensed band) and the cell #2 (unlicensed band) were described. However, the present invention can be applied to a case where a different eNB 200 manages the cell #1 (licensed band) and the cell #2 (unlicensed band).

In the above-described first embodiment to the ninth embodiment, the LTE system is exemplified as the mobile communication system. However, the content of the present invention is not limited to the LTE system. The present invention may be applied to a system other than the LTE system.

Supplementary items of the first embodiment to the ninth embodiment will be described, below.

[Appendix 1]

(Introduction)

In this appendix, the design of reference signal(s) for the LAA RRM measurement is described. The other functionalities taking our approach to the reference signal(s) into account are also described.

(Design of Reference Signal(s) for RRM Measurement)

It was agreed Rel-12 DRS is the starting point for the design of reference signal used in RRM measurements on the unlicensed band. Based on Rel-12 DRS design, the eNB is required to transmit PSS/SSS/CRS (and CSI-RS) at fixed intervals without exception. It can be achieved without any problem because the eNB uses the assigned licensed band resources to transmit the DRS. However, in contrast to the licensed band, more than one radio systems/nodes could share the unlicensed band. In addition to sharing the unlicensed band, each system use LBT (listen before talk) to avoid collisions which is required in some countries/regions. Therefore, in our view LBT is required when DRS is transmitted on the unlicensed band.

One design aspect is to consider whether LBT should be a mandatory function or not. LBT is a mandatory function in EU and Japan, but EU regulation allows the transmission of management and controlling frames without sensing the frequency for the presence of a signal i.e., Short Control Signaling Transmission. According to the EU regulation, the Short Control Signaling Transmissions of Adaptive equipment shall have a maximum duty cycle of 10% within an observation period of 50 msec. Based on the above requirement if the DRS transmission satisfies the conditions, the LTE eNB can transmit DRS on the unlicensed band without performing the LBT. However, it believes the LBT should be mandated because it helps to obtain fair coexistence with the other systems and avoid collisions. The LBT mandate could also be viewed as a simple design and provide one universal solution for all the regions where LAA is expected to be deployed.

Proposal 1: RAN1 should agree to apply LBT functionality to the Rel-12 DRS based LAA DRS transmissions.

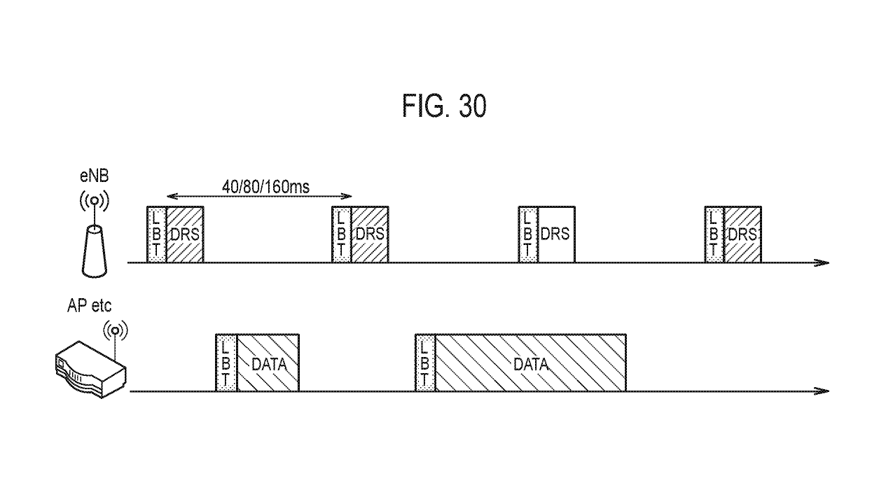

If Proposal 1 is accepted as an agreement, the LBT functionality does not allow the eNB to transmit its DRS on the unlicensed band if a busy channel is detected (See FIG. 30). As a consequence, the measurement accuracy requirement may not be satisfied when the eNB does not transmit DRS during some of the DRS transmission opportunities. According to the current definition of RSRP measurement the UE shall measure RSRP in the subframes configured as discovery signal occasions. It means UE must monitor the configured radio resources and may include those resources' results in the final measurement result regardless of whether DRS were actually transmitted or not in those resources.

In addition, the number of resource elements within the considered measurement frequency bandwidth and within the measurement period that are used by the UE to determine RSRP is left up to the UE implementation with the limitation that corresponding measurement accuracy requirements have to be fulfilled. Therefore, there is a possibility that the reported RSRP could be highly inaccurate. The combination of UE implementation based RSRP measurements and unavailability of some of the DRS transmissions due to eNB's LBT functionality results into a problem where the UE is unable to provide an accurate unlicensed band's radio environment information to the eNB.

We believe the above issue must be addressed in RAN4. One approach is RAN1 sends a request LS to RAN4 to perform a study to verify if the current measurement accuracy requirement is satisfied by the existing specification. In case the current specification does not satisfy the accuracy requirement then new solutions can be considered. The following are some of the candidate alternatives.

Alternative 1: eNB broadcast/unicast a DRS measurement indication on the licensed band.

In this alternative, the eNB inform the UE(s) via the licensed band about the conditions under which subframe RSRP should be calculated. During the RSRP calculations, the UE is expected to adopt and modify its DRS measurements in accordance to the information provided by the eNB about the RSRP measurement conditions on the unlicensed band. FFS when and how the eNB can provide this information to the UEs.

Alternative 2: To define a CRS (included in DRS) based RSRP measurement for LAA.

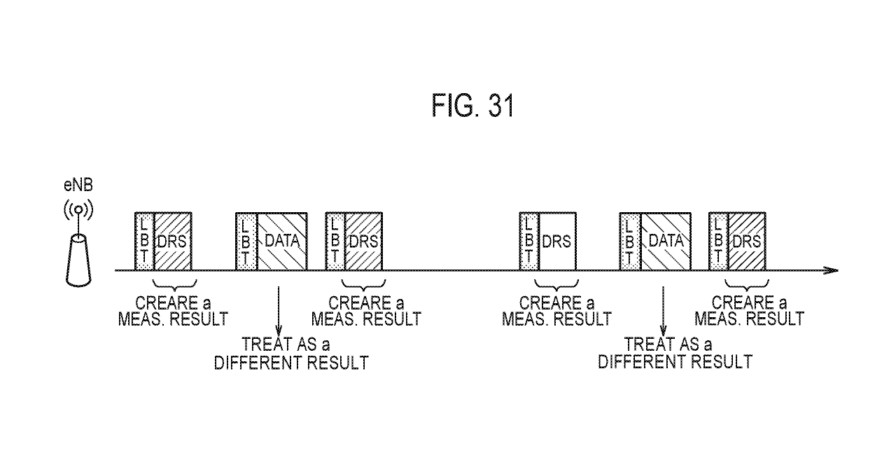

In this alternative, some limitation is applied how a UE performs the DRS measurements to determine RSRP. For example, UE should send one measurement result per one DRS burst (See FIG. 31). Since eNB is aware which DRS was transmitted on the unlicensed band, the eNB can determine if the received measurement report from a particular UE is reliable or not.

Proposal 2: If Proposal 1 is accepted as an agreement, RAN1 should send a LS to RAN4 requesting if the measurement accuracy requirement is satisfied by the existing specification.

(Analysis of Functionalities for LAA)

Unlike RRM measurement, the reference signals for supporting other functionalities were not addressed in the previous meeting. If proposal 1 is accepted as an agreement, then the Rel-12 DRS with LBT should be the starting point for other functionalities as well. We believe the AGC setting, coarse synchronization and the CSI measurements can be performed using the above DRS for LAA. It could be a baseline solution; however, further study is needed for the case when the eNB does not transmit DRS during some of the DRS transmission opportunities. As discussed before this situation is similar to the RRM measurement.

On the other hand, fine frequency/time estimation for at least demodulation may not be achieved if eNB cannot transmit DRS more than the current specified maximum DRS interval. The existing specification is not guaranteed the DRS interval longer than 160 msec. We discuss this issue further in the next section.

Proposal 3: The LAA DRS based on Rel-12 DRS with LBT should also be used for AGC setting, coarse synchronization and the CSI measurement.

(Synchronization Signal Design)

As mentioned before the LBT based transmission is needed in the unlicensed bands in various countries/regions; therefore, there is a possibility that eNB may not be able to transmit DRS on the unlicensed band for a long period of time due to the presence of other transmissions by the neighboring nodes sharing the same band. One approach is to set a fix maximum limit for the duration between the two DRS transmissions, for example 160 msec. If eNB cannot transmit DRS a longer time than the maximum limit, it should be assumed fine frequency/time estimation is not guaranteed. However, it also possible due to interference a UE was unable to detect/decode some of the DRS transmissions correctly. This situation forces us to consider providing another synchronization signal within the data transmissions in addition to the DRS transmissions. One solution is the eNB transmits the synchronization signals (LAA sync) in the symbols located before the data region (e.g., the first symbols of a subframe). This approach is very similar to the D2D synchronization signal design. In that case, UE achieve a coarse synchronization using the DRS and achieve finer frequency/time estimation using the above LAA sync. If this solution is applied, AGC setting is performed based on the LAA sync instead of the DRS as the LAA sync is located next to the data region within the first subframe received at the UE.

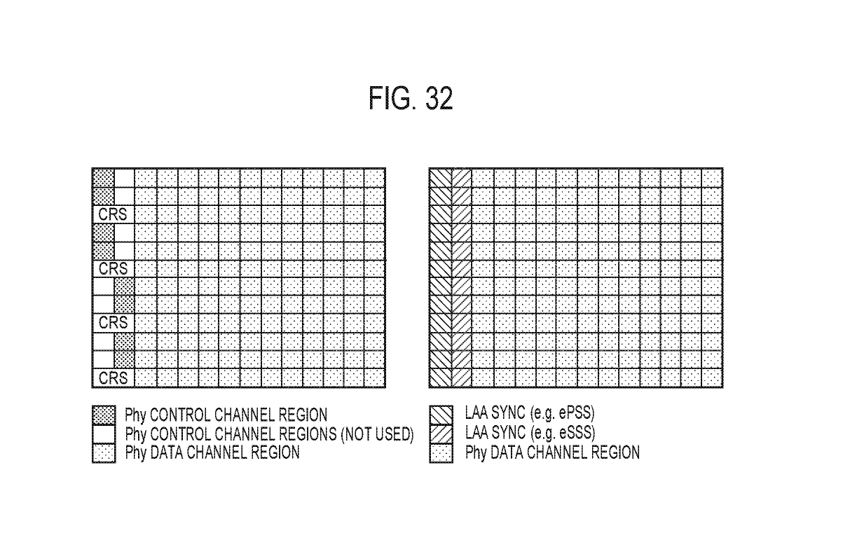

FIG. 32 is a diagram illustrating an example of an existing channel mapping (left) and a proposed channel mapping (right).

We propose the current Physical control channel regions should be replaced by LAA sync. The number of resource elements used to transmit Physical control channels is changed according to e.g., the number of UEs scheduled in the subframe. In case of low-traffic conditions it is possible Physical control channel regions is not fully occupied resulting in low resource element density and consequent low transmit power over the OFDM symbol resulting in higher miss-detection by the neighboring nodes. This results in the collisions as the neighboring nodes may assume the channel is available for their respective transmissions. To avoid the collisions, we propose Physical control channels should be removed from the unlicensed band transmissions and LAA sync should be transmitted as a replacement. Further study is needed how LAA sync is mapped on the right before data region.

Proposal 4: The current Physical control channels region should be replaced by this LAA sync.

[Appendix 2]

(Introduction)

It is well known as more access points share the same channel the more system throughput performance is degraded. For fair coexistence between the Wi-Fi and the LAA services, it is proposed that the similar WiFi mechanisms need to be introduced for LAA operation such as Listen-before-talk (Clear channel assessment) and discontinuous transmission on a carrier with limited maximum transmission duration. Therefore, it is assumed throughput performance degradation cannot be avoided as long as LAA cell share the same band with other access points.

On the other hand, it's worth studying the coordination mechanism between the LAA services of different operators. The coordination mechanism consists of channel selection and channel sharing between multi-operator LAA services. This coordination could result into better interference management. In this appendix, it is presented a mechanism for the tight coordination mechanism between more than one LAA services, in particular the LTE Beacon, the LTE Header and a new UE measurement report.

(Possible Functionalities of LTE Beacon)

It is preferable if the LAA cell (re)select the lowest loaded channel for its operation. In order to achieve this aim the LAA cell should be aware of the radio environment of unlicensed band. It is proposed that the unlicensed spectrum usage information is shared with the neighboring nodes by broadcasting the information. This broadcast information is delivered over the “LTE Beacon”. The neighboring LAA services can detect neighboring LTE Beacons and then select a channel using that information and set their own LAA parameters appropriately. After receiving the above information the neighboring eNBs can also broadcast their own beacon as well. One of the candidate contents of LTE Beacon is the traffic load information of unlicensed spectrum, the number of LBT failures or the number of usage channels.

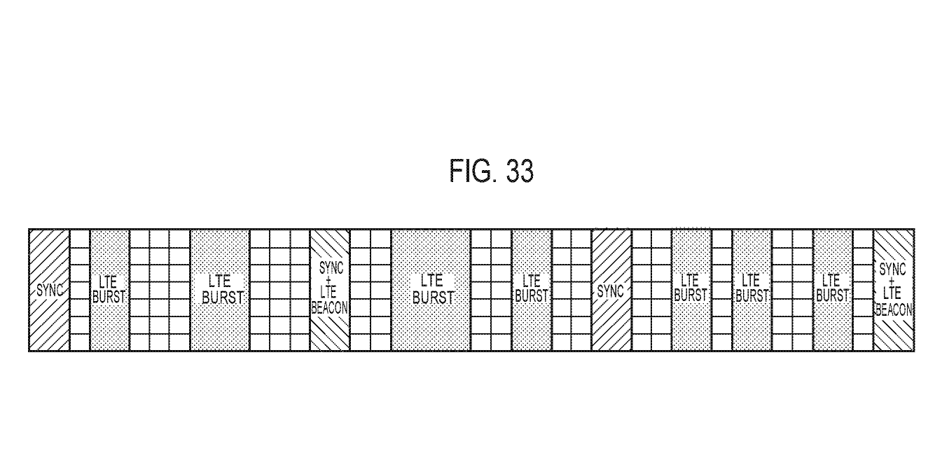

In addition, LTE Beacon can also be used for sharing one unlicensed spectrum CC by more than one LAA service. It can be assumed different operator LAA cells share the same channel in the time division manner. The configurations of unlicensed spectrum's synchronization signal and/or reference signal are provided on the proposed LTE Beacon resulting a tighter coordination. A study is needed for the transmission timing of the LTE Beacon. In our opinion, it should be transmitted on the same subframe in which the synchronization signals are transmitted. This is very much similar to concept of Broadcast channel (PBCH) which is located on the same subframe along with the PSS/SSS. An example of LTE Beacon transmission is shown in FIG. 33. It is necessary to further discuss if the LTE beacon should be transmitted with every synchronization signal transmission.

Proposal 1: The unlicensed spectrum usage information should be broadcasted to other operators over LTE Beacons.

(Possible Functionalities of LTE Header)

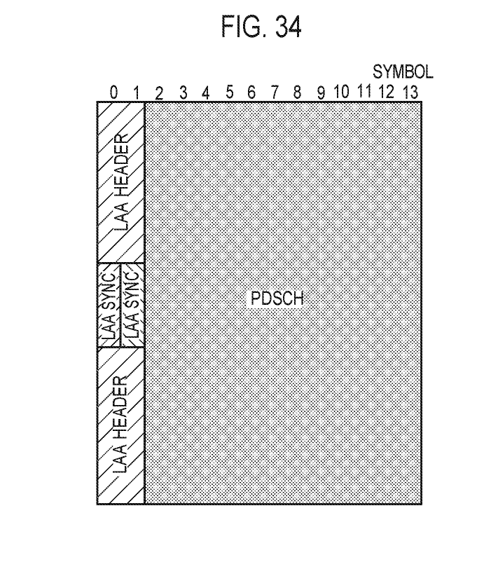

This section considers further sharing of LAA cell's resource allocation information resulting in further efficient usage of the unlicensed spectrum. For example, if the LAA cell is aware of the data transmission duration of the other LAA cell then eNB can suspend LBT during that duration. Therefore, it is proposed that RAN1 should study if some level of resource allocation information on the unlicensed spectrum should be broadcasted as well. This information should be conveyed over the “LTE Header” and transmitted in a header located at the beginning of the data burst. It's assumed the LTE Header has a similar function as the current Rel-8 PDCCH. This header can be read by the neighboring LAA cells to obtain resource usage information by the transmitting eNB. The example of how to arrange LAA Header is illustrated in FIG. 34. FIG. 34 is also shown the LAA sync. It is necessary to further discuss the location of LAA Header

Proposal 2: RAN1 should study if some level of resource allocation information on the unlicensed spectrum should be broadcasted in a header signal.

(UE Measurement Enhancement)

RAN1 should study if the hidden node problem should be taken into account when designing the channel selection procedures/schemes. To deal with the hidden node problem, it is proposed to introduce a new UE measurement report mechanism. In the measurement report, UE report the detecting Cell ID and signal power on the unlicensed band in addition to the current RRM measurement result. In our view, UE can detect the non-serving cell's DRS (including other operator's LAA) and calculate the DRS RSRP by itself. The eNB that receives this report from the UE can take appropriate action needed to mitigate the hidden node problem.

Proposal 3: New UE measurement report mechanism should be introduced that allows a UE to report the detected non-serving LAA cell's information.

In addition, there is a potential issue if the same PCI is used by multiple operators. Same PCI should not be allocated to the neighboring cell. Within an operator's network, it can be achieved by cell planning or SON function. However, the problem remains when the same PCI is used by other operators located in the proximity of the first operator. In our opinion, either UE assisted or eNB based PCI collision avoidance mechanism in unlicensed spectrum should be introduced.

Proposal 4: PCI collision avoidance mechanism in unlicensed spectrum should be introduced.

[Appendix 3]

(Introduction)

In this appendix, functionalities need to be supported at the beginning of discontinuous LAA DL transmission, are considered.

(Considerations on the Beginning of DL Transmission)

Proposal 1: Coarse synchronization should be supported by LAA DRS. Fine time/frequency tuning provided by the LAA sync should be supported at the beginning of the data burst.

Proposal 2: The current Physical control channels region should be replaced by the LAA sync.

(Broadcast Channel for Resource Allocation Information)

If the LAA cell is aware of the data transmission duration of the other LAA cell then eNB can suspend LBT during that duration. Therefore, it is proposed to study if some level of resource allocation information on the unlicensed spectrum should be broadcasted as well. This information should be conveyed over initial signal located at the beginning of the data burst. This signal is read by the neighboring LAA cells to obtain resource usage information of the transmitting eNB.

Proposal 3: It should study if some level of resource allocation information on the unlicensed spectrum should be broadcast in the initial channel.

The following functionalities is supported at the beginning of the data burst.

Proposal 4: The following functionalities should be placed at the beginning of the data burst.

1) AGC setting

2) Time & frequency synchronization

3) Detection of the LAA transmission

4) Information for Cell ID/Operator ID and resource information of the data transmission

(The Physical Channel Design for Initial Signal)

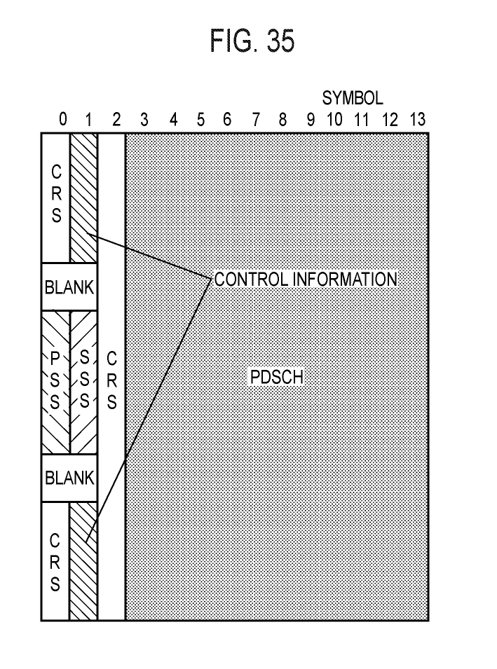

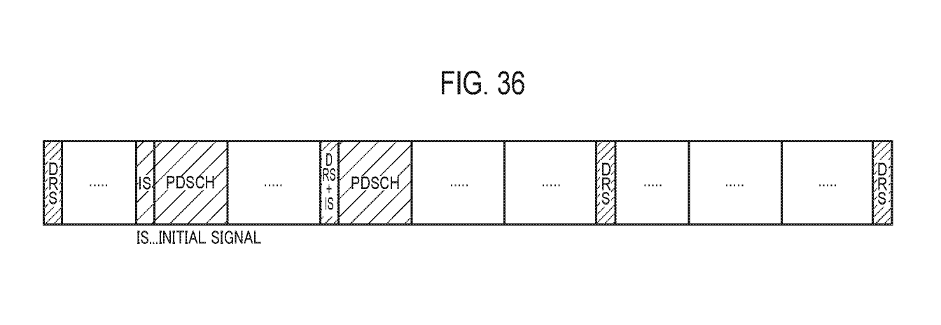

FIG. 35 shows an example of the initial signal design. In our view, DRS and initial signal have similar requirement such as synchronization and broadcasting control information. Therefore, it is proposed the same DRS design to be used for the initial signal. Note that it is interpreted that initial signal doesn't consist of the reservation signal and the design of the reservation signal. The difference between initial signal and DRS should be very small, for example, to indicate a distinction between the two channels 1 -bit flag can be used for that purpose. If DRS timing and initial signal timing collide, DRS and initial signal can be multiplexed by utilizing control information as shown in FIG. 36.

Proposal 5: The same design structure is used for initial signal and DRS.

Proposal 6: The difference between initial signal and DRS should be in the control information part.

[Appendix 4]

(Introduction)

This appendix discusses the design of DRS.

(DRS Transmission and LBT Scheme)

At the previous meeting, RAN1 discussed DRS transmission and agreed on Alt1 and Alt2 for the case where LBT is applied. This section discusses these two alternatives and the LBT method for DRS transmission.

In the Alt1 case the impact on the specification and the UE's receiver complexity are negligible because UE can just follow the DMTC. However, adequate synchronization accuracy may not be achieved and/or necessary RRM measurement may not be available when the LBT doesn't succeed for a long period of time. It causes severe impact on data reception and/or RRM functionality.

On the other hand, in the Alt2 case the UE can maintain synchronization accuracy and RRM measurement availability from DRS transmitted in another subframe(s) even if LBT doesn't succeed within the fixed subframe(s) at the cost of an increase in UE's complexity to search the multi-subframe(s) configured by enhanced DMTC. Furthermore, UE may need to be aware of the DRS subframes for RRM measurement (e.g. replica sequence generation based on subframe/slot number, estimation of the next DRS occasion, etc.).

Above discussion is summarized in Table.1. In our opinion, Alt1 is preferred to avoid increase in UE complexity and if the synchronization accuracy and the RRM measurement requirements are met with or without any enhancements. RAN1 should evaluate Alt1's impact on synchronization and RRM measurement.

Proposal 1: RAN1 should evaluate Alt1's impact on synchronization and RRM measurement, and ask RAN4 for the corresponding requirements if needed. RAN1 should consider possible enhancement to agreed alternatives.

TABLE 1

| | Advantage | Disadvantage |
|---|---|---|
| Alt1 | Low UE complexity | Synchronization inaccuracy |
| | Small specification | Low RRM measurement availability |
| | impact | |
| Alt2 | Synchronization accuracy | High UE complexity |
| | High RRM measurement | Large specification impact including |
| | availability | additional subframe number information |

At the previous RAN1 meeting, it was proposed that DRS design should allow DRS transmission on an LAA SCell subject to LBT. The LBT scheme is mainly divided into FBE and LBE. In our view, FBE is preferable in the case of DRS transmission because DRS is used as broadcast signals/information which is always received by all serving UEs and the fixed timing of the transmissions is beneficial from the UE complexity perspective. If LBE is applied, UE needs to search the DRS timing for every transmission resulting in higher battery consumption.

Proposal 2: LBT based FBE should be applied for DRS

(Physical Design of LLA DRS)

In our view, following information should be transmitted by LAA SCells in the LAA DRS.
PSS/SSS/CRS/(CSI-RS)
Control information
Beacon

According to the RAN1 agreement, LAA DRS should at least support the RRM measurement. Therefore, LAA DRS should include PSS/SSS/CRS for fulfilling this requirement.

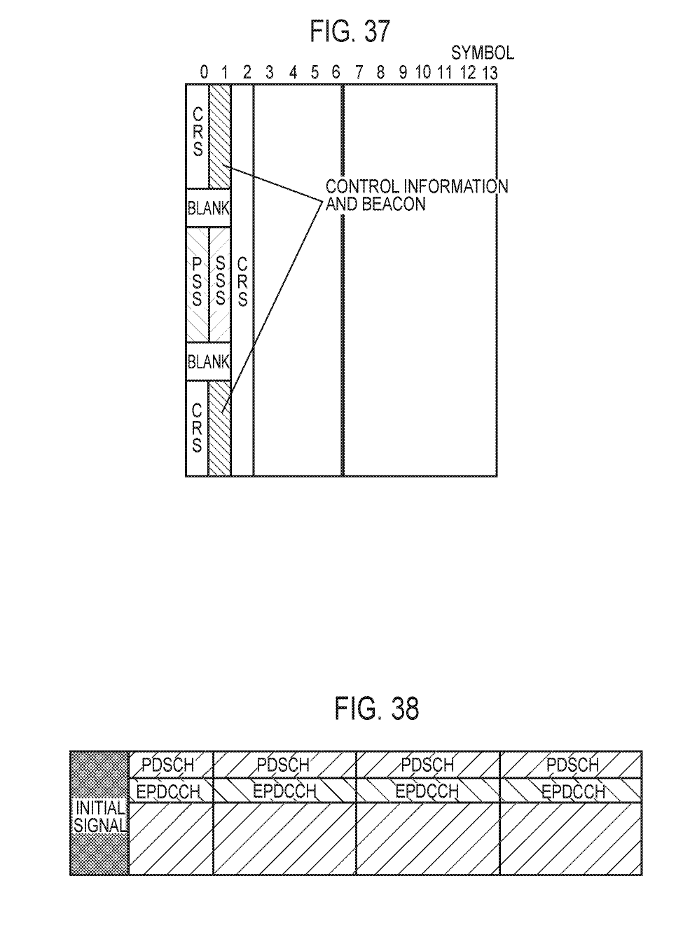

For the unlicensed band, there is the European regulation about the Occupied Channel Bandwidth. According to the regulation, more than or equal to 80% of resources within an OFDM symbol should be filled by some signals if the system bandwidth is less than or equal to 40 MHz. The DRS includes the synchronization signals (PSS/SSS) occupying only 1.4 MHz (6RB) in the center of the system bandwidth and any signals transmitted on the other resources are not specified explicitly. Therefore, there could be lot of waste of system bandwidth in the wider system bandwidth deployments, which is not allowed by the regulation. One of the possible solutions is expanding the synchronization signals in frequency domain (e.g. correspond to system bandwidth). However, this solution significantly impacts the specification and increases the UE complexity (for example, detection of various synchronization signal sizes, etc.). In our view, RAN1 should discuss other approaches such as filling the unused resources with specific signals as shown in FIG. 37. Specific signals should be arranged to cover almost all the remaining bandwidth in the OFDM symbol with certain density to avoid potential miss detection in CCA by other devices (e.g. WiFi) due to low power density in the OFDM symbol.

Proposal 3: RAN1 should reuse the current synchronizations signals for LAA DRS and discuss to fill in the blank resources with some specific signals.

Control information provides the LAA cell information which includes at least resource mapping information and PLMN ID. In addition, subframe number and subset of SFN are used at least for the Alt 2 DRS transmission to confirm the current subframe number and subset of SFN. If current subframe number and subset of SFN are corresponding to the fixed subframe configured via DMTC by serving Cell, UE can become aware that the received DRS was transmitted at the fixed subframe. In the Alt 1 case, the subframe number and subset of SFN may not be needed.

Resource mapping information provided on the Control information indicates PDSCH resource allocation information when DRS transmission occurs simultaneously with PDSCH transmission.

In our view, cell(s) should simultaneously transmit PDSCH and DRS when PDSCH transmission is scheduled in the same subframe as DRS occasion.

Proposal 4: LAA DRS subframes should include the Control information which provides the LAA cell information.

Beacon includes the information, which is related to spectrum usage, used by neighboring cells. The neighboring LAA cells can detect the beacon and then select an appropriate channel to be used in their own LAA cells taking this information into account. The content of beacon could be related to the traffic load of unlicensed spectrum, the number of LBT failures and/or the number of the carriers used.

Proposal 5: LAA DRS subframes should include the Beacon which includes the information, which is related to spectrum usage, used by neighboring cells.

[Appendix 5]

(Introduction)

This appendix considers the necessity of LAA control channel for LAA scheduling in unlicensed band and how to specify LAA scheduling.

(The Necessity of Self-Scheduling)

Regarding LAA scheduling, self-scheduling and cross carrier scheduling can be considered. In unlicensed band, the support of multiple component carriers (CC) should be considered and each of these CCs need control channels for scheduling. Considering control channel impact on a licensed carrier, we believe self-scheduling in unlicensed band should be supported. According to the current specification, there are 2 control channels for self-scheduling, one is the PDCCH and the other is the EPDCCH. It is believed that the original PDCCH cannot be reused due to the regulation issue. Therefore, we support the reuse of EPDCCH for LAA scheduling. In addition, the PDCCH can be replaced by a new channel we call Initial Signal. FIG. 38 illustrates one example of channel allocation for the LAA DL transmissions.

Proposal 1: Self-scheduling in unlicensed band should be supported.

Proposal 2: Only the EPDDCH based self-scheduling for LAA should be supported.

(Consideration of Scheduling Algorithm)

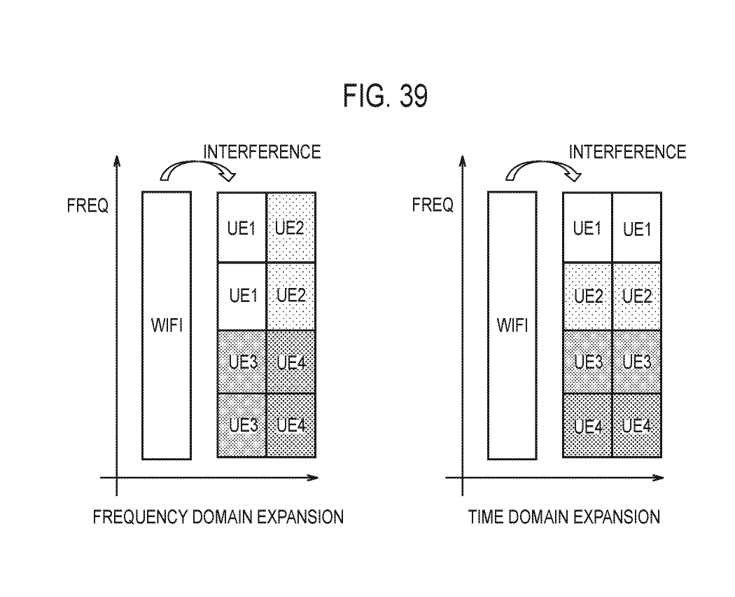

In Wi-Fi, whole bandwidth is occupied by one user. We believe the mitigation of Wi-Fi by scheduling can be considered. LTE should use time domain expansion allocation rather than frequency domain expansion scheduling for reducing the impact on LAA from Wi-Fi as shown in FIG. 39. Regarding multiple subframes allocation to each UE, it can be specified by tti-bundling or channel coding in time contiguous RBs. Additionally, multi-subframe scheduling reduces the control channel overhead.

Proposal 3: Multi-subframe scheduling by one DCI should be considered for LAA.

[Appendix 6]

A base station according to appendix 6 comprises a controller configured to transmit downlink data in an unlicensed band. The controller determines a start timing to start transmitting the downlink data, out of candidate start timings that are timings previously defined in a subframe.

(Introduction)

3GPP studied the use of unlicensed spectrum in combination with licensed spectrum and reported the results. Taking these results into consideration, RAN#68 approved a new WI “Licensed-Assisted Access using LTE” for specifying LAA SCells operations with only DL transmissions. In this contribution, view on DL transmission design is provided.

(DL Transmission Design)

According to the reported results, Category 4 LBT mechanism is the baseline at least for LAA DL transmission bursts containing PDSCH. If Category 4 LBT mechanism is applied to PDSCH transmission, it is necessary to discuss DL transmission timing, reservation signal which reserves the channel and initial signal which indicates UE a start timing of DL transmission. We show our overview of DL transmission design in FIG. 29. This section discusses details of DL transmission timing and signal designs. In this appendix, the part consisting of initial signal, PDCCH and PDSCH is referred as DL data transmission.

DL Data Transmission Timing

CCA ends regardless of subframe boundary when Category 4 LBT mechanism is applied. After reservation signal transmission following CCA end, there are two choices on DL data transmission start timing; whether DL data transmission should always start after waiting until the next subframe boundary or not.

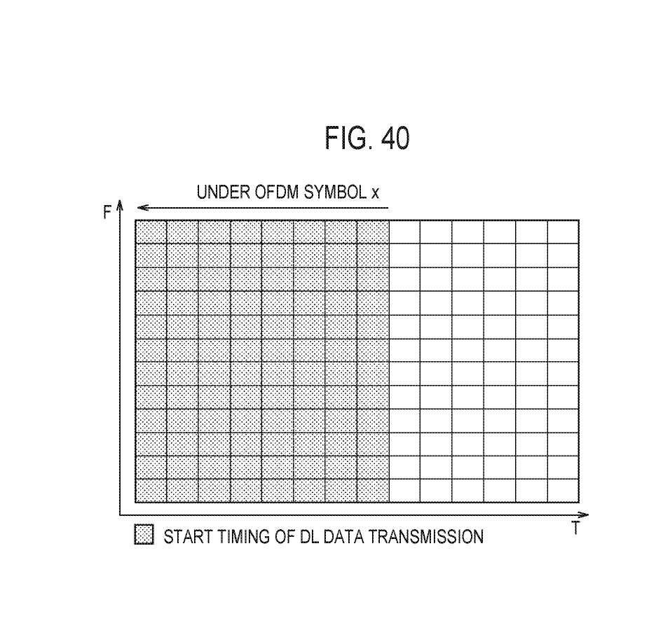

Considering the frequency efficiency, DL data transmission should be able to start without waiting until the next subframe boundary especially when maximum DL transmission burst duration is short (e.g. max 4 ms burst in Japan regulation). For example, when reservation signal is transmitted during all over partial subframe, reservation signal occupies maximum 25% of DL burst transmission in case of 4 ms burst transmission. However, supporting all OFDM symbols as start timing candidates leads computationally intensive and complex in both eNB and UE. For example, eNB should prepare plurality of packets with different TBSs for PDSCH because eNB cannot realize the CCA ending point before trying CCA process. Additionally, UE must search all the possible start timings of DL data transmission because UEs don't know when eNBs start DL data transmission. This makes UEs more complex and computationally intensive than traditional manner. One solution is limiting the start timings of OFDM symbols. Besides, it is assumed that a limited start timing should be located earlier than certain OFDM symbol x in subframe (FIG. 40). If start timing is located later than certain OFDM symbol x in subframe, coding rate of PDSCH might be too high to be decoded, which makes UE cannot decode the PDSCH correctly without retransmission. It is necessary to further discuss the value of x.

Proposal 1: Limiting the start timing of DL data transmission is preferable from the aspect of eNB and UE computational load and complex. Additionally, candidate of limited start timing should be located earlier than certain OFDM symbol x in subframe.

Reservation Signal

There is a time gap between CCA end and start timing of DL data transmission. If eNB doesn't transmit anything during this time gap, other devices (e.g. APs or other operator's eNB) may transmit any signals. Therefore, eNB should transmit the reservation signal.

Proposal 2: Reservation signal should be used to prevent interruption by other devices.

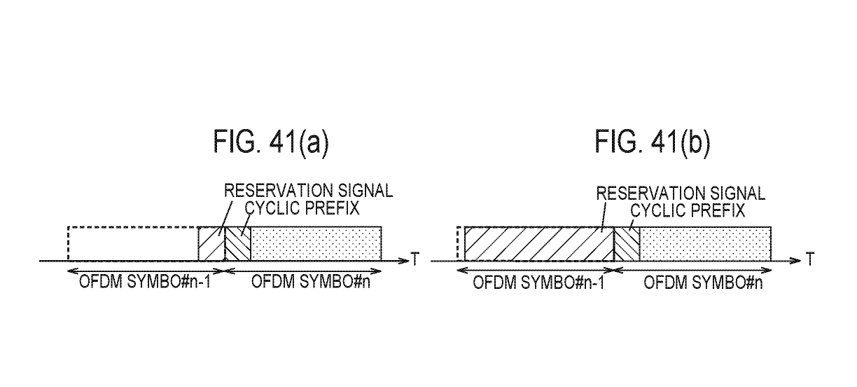

The reservation signal is divided into two patterns according to whether length of reservation is shorter than an OFDM symbol or not. If time length of reservation signal is shorter than one OFDM symbol, this gap is not long enough to transmit any data. However, eNB can transmit the CP (cyclic prefix) extension of next OFDM symbol in this gap (see FIG. 41(a)). The transmission of the CP extension improves the detection performance of the initial signal. However, if the total duration of the reservation signal that includes the CP extension portion and the next OFDM symbol CP is greater than one effective OFDM symbol length then UE may not be able to determine the symbol-timing due to dual-peak detection. (e.g. reservation signal=60 us and CP=16.7 us) (See FIG. 41(b)).

Proposal 3: In the case that reservation signal is shorter than one OFDM symbol, at least a part of reservation signal should be used as CP extension. However, the total duration of CP extension and the next OFDM symbol CP should be shorter than the effective OFDM symbol length.

On the other hand, if time length of reservation signal is longer than one OFDM symbol, eNB would transmit redundant data which may be used for supporting DL data transmission. However, reservation signal shouldn't include any critical data which UE must receive. One option is using as the CP extension just before the start timing of DL data transmission only.

Proposal 4: When reservation signal is longer than one OFDM symbol, reservation signal shouldn't include any critical data which UE must receive in order to avoid UE complexity.

Initial Signal

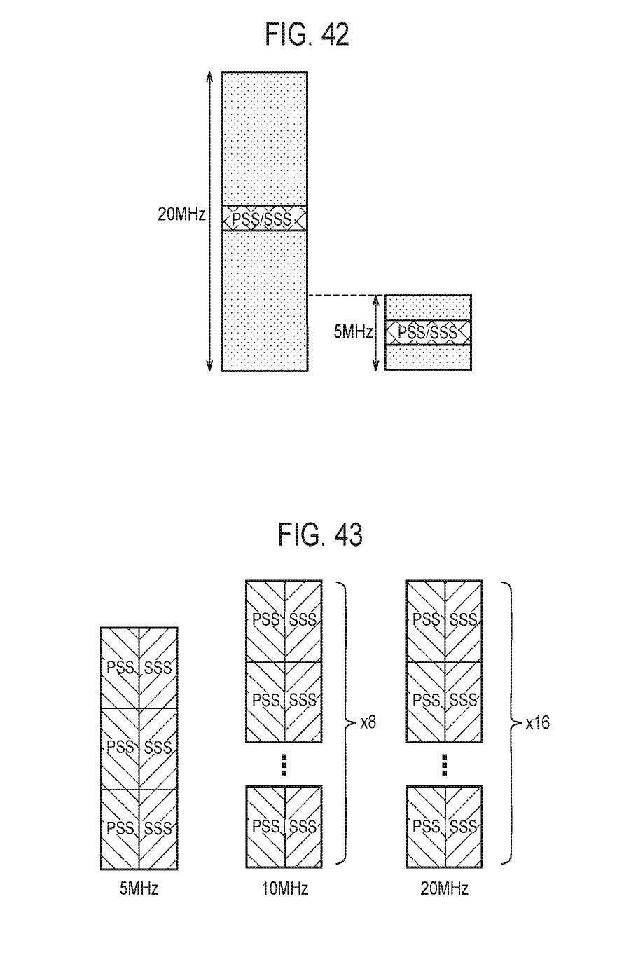

UE needs to be aware of start timing of DL data transmission. UE would perform blind decoding to detect the start timing of DL data transmission at every candidate timings. However, blind decoding requires computationally intensive for the UE. It is preferable to define an initial signal to notify the start timing of DL data transmission. One candidate signal is PSS/SSS within one or two OFDM symbol(s) which is easy to detect. However, legacy PSS/SSS maps in the center of system bandwidth (FIG. 42). This does not allow to reserve the channel with respect to devices operating in the partial bandwidth overlapping cases. One solution is to map multiple PSS/SSS within the bandwidth shown by FIG. 43.

Proposal 5: Initial Signal is used for indicating the start timing of DL data transmission and maps multiple PSS/SSS within one or two OFDM symbols.

On the other hand, UE cannot understand whether this signal is initial signal or DRS if the same physical designs are used. One simple solution is using the different sequence of SSS between DRS and initial signal.

PDCCH/PDSCH

Basically, it is assumed that the PDCCH and PDSCH format is not changed except preparing the multiple DCIs and packets with different TBSs for PDSCH, because eNB is not aware in advance when the CCA ends. Additionally, it is necessary to define new TBS to adopt the partial subframe. One simple approach is to change the TBSs in proportion to the number of available OFDM symbols for PDSCH. For example, when available OFDM symbols is 5 with normal CP, transmitting TBS is floor (5/14*TBS/8)*8.

If eNB couldn't support to prepare multiple packets with different TBSs for PDSCH, another way to resolve this issue is to have the eNB to transmit the smallest packet for the worst case number of OFDM symbols available. The resolution has lower complexity in exchange of higher partial subframe transmission inefficiency.

Proposal 6: RAN1 should consider different TBS sizes to handle different transmission durations.

### INDUSTRIAL APPLICABILITY

The present application is useful in the field of communication.

1. A base station used in a mobile communication system, comprising:
a transmitter configured to transmit, in an unlicensed band, a control signal and data by using a downlink subframe; and
a controller configured to control transmission by the transmitter, wherein
the downlink subframe includes a PDCCH interval in which the control signal is arranged and a PDSCH interval in which the data is arranged, and
in the PDCCH interval, if there is an available region where the control signal is not arranged, the controller arranges a dummy signal in the available region.

2. The base station according to claim 1, wherein
the dummy signal is a downlink synchronization signal.

3. The base station according to claim 1, wherein the dummy signal is a control signal in which an RNTI is applied, the RNTI being unassigned to a user terminal subordinate to the base station.

4. A base station used in a mobile communication system in which a downlink subframe including a PDCCH interval in which a control signal is arranged and a PDSCH interval in which data is arranged is defined, comprising:
a first transmitter configured to transmit the control signal, in a licensed band; and
a second transmitter configured to transmit, in an unlicensed band, at least the data by using a special downlink subframe, wherein
the special downlink subframe includes a specific interval corresponding to the PDCCH interval, and
the specific interval is an interval where neither the control signal nor the data is arranged.

5. The base station according to claim 4, wherein
in the specific interval, a specific downlink radio signal different from the control signal is arranged.

6. The base station according to claim 5, wherein
the specific downlink radio signal is at least one of: a downlink synchronization signal, a downlink broadcast signal, and a header signal, and
the header signal is a signal including scheduling information corresponding to the control signal.

7. A base station used in a mobile communication system in which a downlink subframe including a PDCCH interval in which a control signal is arranged and a PDSCH interval in which data is arranged is defined, comprising:
a transmitter configured to transmit, in an unlicensed band, at least the control signal and the data by using a special downlink subframe, wherein
the special downlink subframe is a subframe where the control signal and a specific downlink radio signal coexist in the PDCCH interval, and
the specific downlink radio signal is at least one of: a downlink synchronization signal, a downlink broadcast signal; and a header signal.

8. The base station according to claim 7, wherein
the header signal is a signal including scheduling information corresponding to the control signal.

9. The base station according to claim 7, wherein
the specific downlink radio signal is arranged in part of symbol intervals in the PDCCH interval of the special downlink subframe, and
the specific downlink radio signal is arranged across an entire frequency band of the part of the symbol intervals.

10. The base station according to claim 7, wherein
the specific downlink radio signal is arranged in at least part of symbol intervals in the PDCCH interval of the special downlink subframe, and
in at least the part of the symbol intervals, the control signal and the specific downlink radio signal are arranged in a frequency division manner.

11. The base station according to claim 10, wherein
in at least the part of the symbol intervals, the specific downlink radio signal is arranged in an available region where the control signal is not arranged.

12. The base station according to claim 10, wherein
in at least the part of the symbol intervals, a frequency band where the specific downlink radio signal is arranged is defined, and
the control signal is arranged in an available region where the specific downlink radio signal is not arranged.

13. The base station according to claim 7, wherein
in the PDCCH interval of the special downlink subframe, instead of the control signal, a header signal including scheduling information corresponding to the control signal is arranged.

14. A base station, comprising:
a controller configured to perform self-scheduling in an unlicensed band, wherein the controller performs a process of transmitting scheduling information to a user terminal by using an enhanced physical downlink control channel (ePDCCH).

15. The base station according to claim 14, wherein
the controller performs a process of transmitting a header indicating positions of a plurality of ePDCCHs and transmitting the plurality of ePDCCHs along the positions of the plurality of ePDCCHs.

16. The base station according to claim 14, wherein
the controller performs a process of transmitting a header indicating a position of one ePDDCH, transmitting the one ePDDCH along the position of the one ePDCCH, and thereafter, transmitting another subsequent ePDCCH according to a predetermined principle.
